(19) United States
(12) Patent Application Publication
(10) Pub. No.: US 2023/0064134 A1
(43) Pub. Date: Mar. 2, 2023

(54) OPTICAL UNIT

(71) Applicant: NIDEC CORPORATION, Kyoto (JP)

(72) Inventors: Takayuki IWASE, Kyoto (JP); Tomohiro EGAWA, Kyoto (JP); Genki TANAKA, Kyoto (JP)

(21) Appl. No.: 17/894,158

(22) Filed: Aug. 24, 2022

(30) Foreign Application Priority Data
Aug. 25, 2021 (JP) 2021-137525

(51) Int. Cl. H04N 5/225; G02B 7/18

(52) U.S. Cl. CPC H04N 5/2257; G02B 7/1805; H04N 5/2254

(57) ABSTRACT

An optical unit has an optical element, and a holder holding the optical element. The optical element reflects light traveling in a first direction to an intersection second direction. The holder includes a holder body extending in a third direction intersecting the first and second directions, and a side unit extending from the holder body transversely to the third direction. The holder body includes a mounting surface on which the optical element is mounted. The side unit includes an inner surface facing the optical element. The inner surface is connected to an end in the third direction of the mounting surface. The holder body includes a groove at an end of the mounting surface, or the optical element includes a mounted surface mounted on the mounting surface, a side surface facing the inner surface, and a chamfer disposed at a connection between the mounted surface and the side surface.

### CROSS-REFERENCE TO RELATED APPLICATIONS

The present invention claims priority under 35 U.S.C. § 119 to Japanese Patent Application No. 2021-137525 filed on Aug. 25, 2021, the entire content of which is incorporated herein by reference.

### FIELD OF THE INVENTION

The present disclosure relates to an optical unit.

### BACKGROUND

Image blur may be generated due to camera shake during capturing a still image or a moving image with a camera. A camera shake correction device enabling the capturing of a clear image by preventing the image blur has been put into practical use. When the camera shakes, the camera shake correction device prevents the image blur by correcting the attitude of a camera module in response to the camera shake. The camera shake correction device includes an optical unit. The optical unit includes an optical element that changes a traveling direction of light and a holder that holds the optical element.

For example, a prism device having a prism and a corner stand that holds the prism is known. The corner stand includes a support surface that supports the prism and side walls disposed at both ends of the support surface. The side wall is perpendicular to the support surface.

Meanwhile, in the conventional prism device, the corner stand is usually formed by injection molding resin using a metal mold. That is, the support surface and the side wall are a single member.

However, when the injection molding is repeated, corners of the metal mold are gradually rounded due to a defect. For this reason, an unnecessary portion having a shape corresponding to the defect portion is formed at a connection unit between the support surface of the corner stand and the side wall. That is, the unnecessary portion protruding toward a prism side from the support surface and the side wall is formed at the connection unit between the support surface and the side wall. Consequently, attachment accuracy of the prism with respect to the corner stand decreases because the prism comes into contact with the unnecessary portion.

In the present specification, the defect typically means erosion, but also includes abrasion or chipping due to physical contact. In addition, the erosion means that a high-temperature molten metal comes into contact with the metal mold to mechanically or chemically erode the metal mold. Hereinafter, in the present specification, the defect is described as erosion or the like.

### SUMMARY

An exemplary optical unit of the present disclosure includes an optical element and a holder. The optical element reflects light traveling on one side in a first direction to one side in a second direction intersecting the first direction. The holder holds the optical element. The holder includes a holder body extending in a third direction intersecting the first direction and the second direction, and a side surface unit extending from the holder body in an intersecting direction intersecting the third direction. The holder body includes a mounting surface on which the optical element is mounted. The side surface unit includes an inner side surface facing the optical element. The inner side surface is connected to an end in the third direction of the mounting surface. The holder body includes a groove disposed at an end of the mounting surface, or the optical element includes a mounted surface mounted on the mounting surface, a side surface facing the inner side surface, and a chamfer disposed at a connection unit between the mounted surface and the side surface.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a smartphone including an optical unit according to an embodiment of the present disclosure;

FIG. 2 is a perspective view illustrating the optical unit of the embodiment;

FIG. 3 is an exploded perspective view illustrating the optical unit of the embodiment in which the optical unit is separated into a movable body and a support body;

FIG. 4 is an exploded perspective view illustrating the movable body of the optical unit of the embodiment;

FIG. 5A is a sectional view taken along a line VA-VA in FIG. 2;

FIG. 5B is a sectional view taken along a line VB-VB in FIG. 2;

FIG. 5C is a sectional view taken along a line VC-VC in FIG. 2;

FIG. 5D is a sectional view taken along a line VD-VD in FIG. 2;

FIG. 6 is an exploded perspective view illustrating an optical element and a holder of the optical unit of the embodiment;

FIG. 7 is a view illustrating a structure of the optical element and the holder of the optical unit of the embodiment as viewed from a fourth direction;

FIG. 8 is a view illustrating the structure of the holder in the optical unit of the embodiment from a first direction;

FIG. 9 is a sectional view taken along a line IX-IX in FIG. 6;

FIG. 10 is an enlarged perspective view illustrating a side surface unit of the holder in the optical unit of the embodiment;

FIG. 11 is an exploded perspective view illustrating the optical element, the holder, and a first preload unit of the optical unit of the embodiment;

FIG. 12 is an exploded perspective view illustrating the optical element, the holder, the first preload unit, a first support, and a second magnet of the optical unit of the embodiment;

FIG. 13 is a perspective view illustrating the movable body of the optical unit of the embodiment;

FIG. 14 is a view illustrating the first support of the optical unit of the embodiment as viewed from one side X1 in a first direction X;

FIG. 15 is an exploded perspective view illustrating the support body of the optical unit of the embodiment;

FIG. 16 is a perspective view illustrating a periphery of a second support in the optical unit of the embodiment;

FIG. 17 is a view illustrating the second support of the optical unit of the embodiment as viewed from the other side X2 in the first direction X;

FIG. 18 is a view illustrating the second support, a first protrusion, a second protrusion, and the second magnet of the optical unit of the embodiment as viewed from the other side X2 in the first direction X;

FIG. 19 is a view illustrating a structure of a holder of an optical unit according to a first modification of the embodiment as viewed from the fourth direction;

FIG. 20 is a view illustrating a structure of a holder of an optical unit according to a second modification of the embodiment as viewed from the fourth direction;

FIG. 21 is a view illustrating a structure of a holder of an optical unit according to a third modification of the embodiment as viewed from the fourth direction;

FIG. 22 is a view illustrating structures of an optical element and a holder of an optical unit according to a fourth modification of the embodiment as viewed from the fourth direction;

FIG. 23 is a sectional view illustrating the structure of the optical element in the optical unit of the fourth modification of the embodiment;

FIG. 24 is a view illustrating structures of an optical element and a holder of an optical unit according to a fifth modification of the embodiment as viewed from the fourth direction; and

FIG. 25 is a view illustrating structures of an optical element and a holder of an optical unit according to a sixth modification of the embodiment as viewed from the fourth direction.

### DETAILED DESCRIPTION

With reference to the drawings, an exemplary embodiment of the present disclosure will be described below. In the drawings, the same or corresponding parts are given the same reference signs and description thereof will not be repeated.

In the present specification, a first direction X, a second direction Y, and a third direction Z intersecting each other are appropriately described for easy understanding. In the present description, the first direction X, the second direction Y, and the third direction Z are orthogonal to one another, but are not necessarily orthogonal to one another. One side in the first direction is referred to as one side X1 in the first direction X, and the other side in the first direction is referred to as the other side X2 in the first direction X. One side in the second direction is referred to as one side Y1 in the second direction Y, and the other side in the second direction is referred to as the other side Y2 in the second direction Y. One side in the third direction is referred to as one side Z1 in the third direction Z, and the other side in the third direction is referred to as the other side Z2 in the third direction Z. For convenience, the first direction X is sometimes described as an up-down direction. One side X1 in the first direction X corresponds to a lower side, and the other side X2 in the first direction X corresponds to an upper side. However, the up-down direction, the upward direction, and the lower direction are defined for convenience of the description, and do not necessarily coincide with the vertical direction. The up-down direction is defined just for convenience of the description, and does not limit an orientation during use and assembly of the optical unit of the present disclosure.

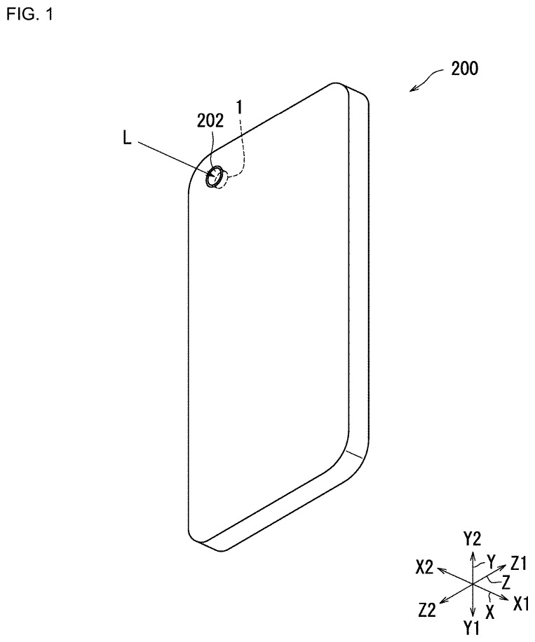

With reference to FIG. 1, an example of application of an optical unit 1 will be described. FIG. 1 is a perspective view schematically illustrating a smartphone 200 including the optical unit 1 according to an embodiment of the present disclosure. The smartphone 200 includes the optical unit 1. The optical unit 1 reflects incident light in a certain direction. As illustrated in FIG. 1, the optical unit 1 is suitably used as, for example, an optical component of the smartphone 200. The application of the optical unit 1 is not limited to the smartphone 200, and can be used for various devices such as a digital camera and a video camera.

The smartphone 200 includes a lens 202 on which light is incident. In the smartphone 200, the optical unit 1 is disposed inside the lens 202. When light L enters the inside of the smartphone 200 through the lens 202, a traveling direction of the light L is changed by the optical unit 1. The light L is imaged by an imaging element (not illustrated) through a lens unit (not illustrated).

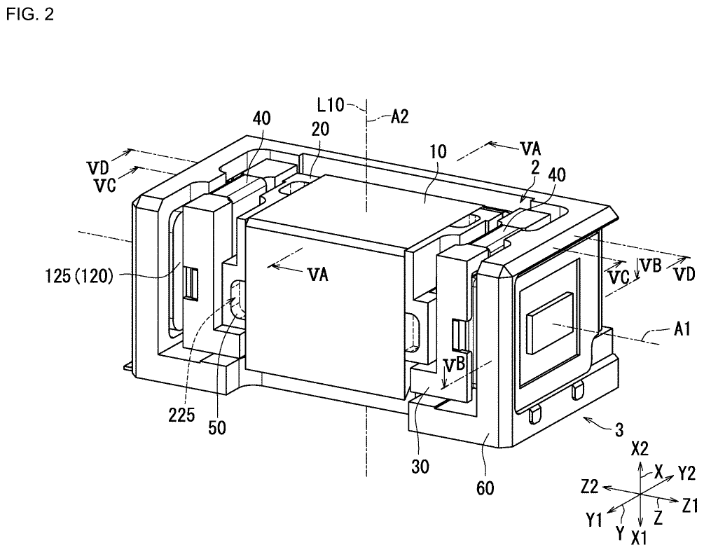

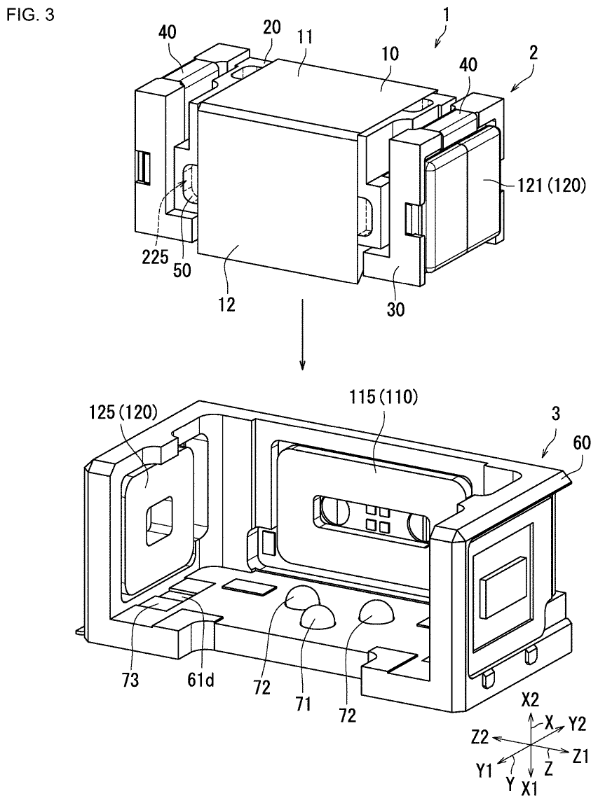

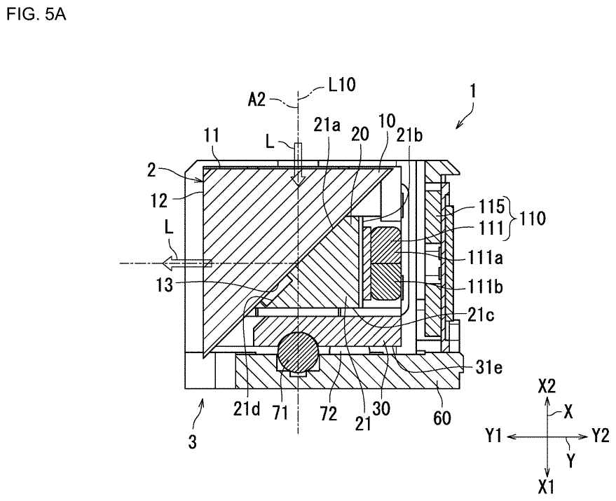

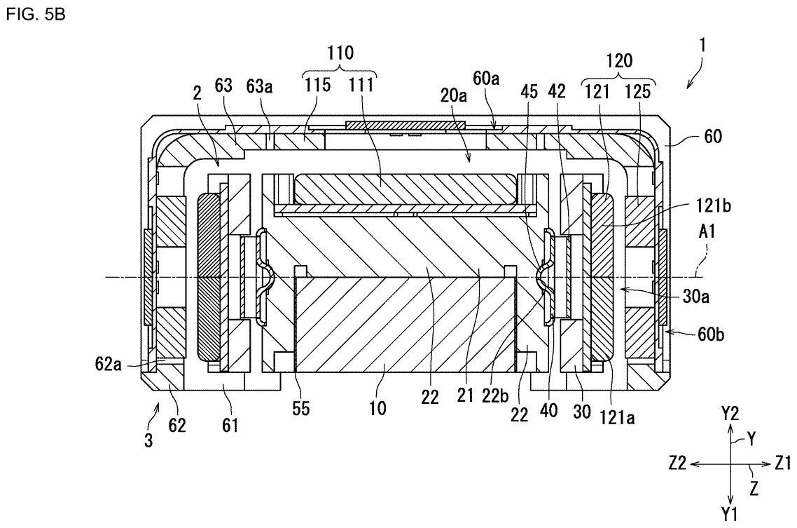

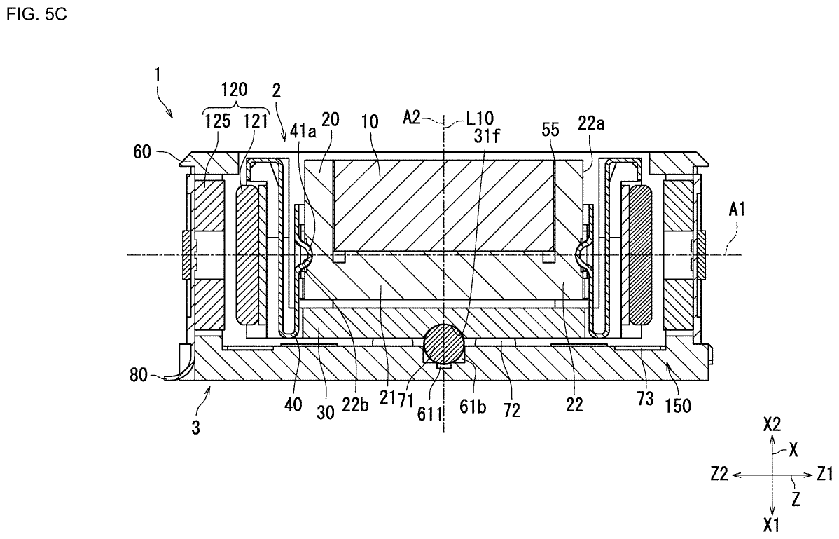

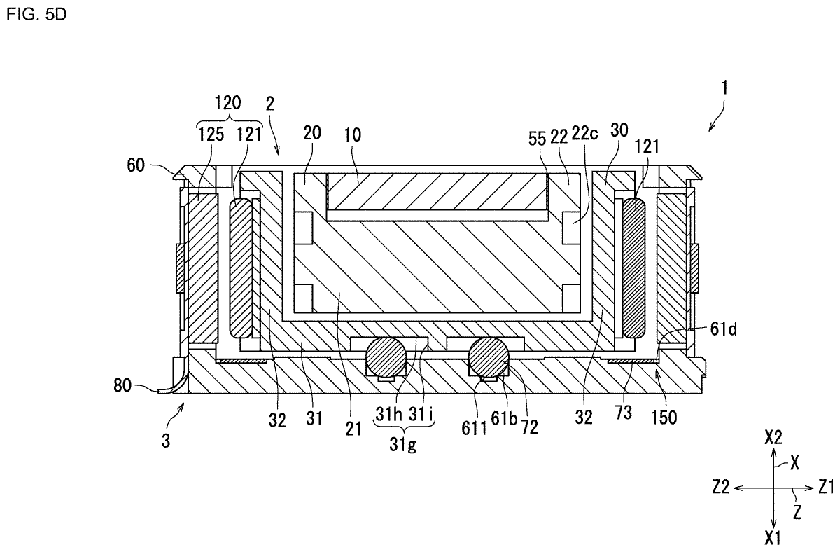

With reference to FIGS. 2 to 18, the optical unit 1 will be described below. FIG. 2 is a perspective view illustrating the optical unit 1 of the embodiment. FIG. 3 is an exploded perspective view illustrating the optical unit 1 of the embodiment in which the optical unit 1 is separated into a movable body 2 and a support body 3. As illustrated in FIGS. 2 and 3, the optical unit 1 includes at least an optical element 10 and a holder 20. In the embodiment, the optical unit 1 further includes a second adhesive member 55 (FIG. 5C). The details will be described below.

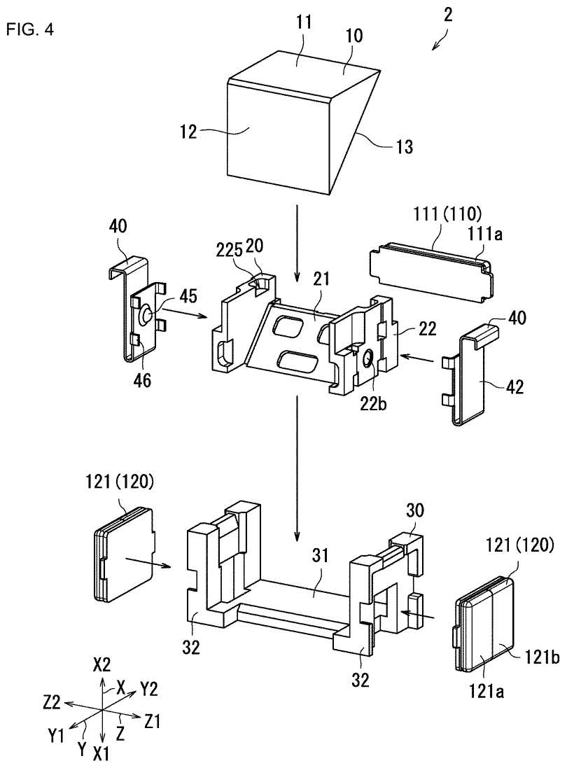

FIG. 4 is an exploded perspective view illustrating the movable body 2 of the optical unit 1 of the embodiment. As illustrated in FIGS. 2 to 4, the optical unit 1 includes the movable body 2 and the support body 3. The support body 3 supports the movable body 2 swingably about a second swing axis A2.

The movable body 2 includes an optical element 10. The movable body 2 includes a holder 20 and a first support 30. The movable body 2 includes the first preload unit 40. The optical element 10 changes the traveling direction of light. The holder 20 holds the optical element 10. The first support 30 supports the holder 20 and the optical element 10 swingably about a first swing axis A1 that intersects the second swing axis A2. The first support 30 is supported by the support body 3 swingably about the second swing axis A2. More specifically, the first support 30 is supported by a second support 60 of the support body 3 swingably about the second swing axis A2.

That is, the holder 20 is swingable with respect to the first support 30, and the first support 30 is swingable with respect to the second support 60. Accordingly, the optical element 10 can be swung about each of the first swing axis A1 and the second swing axis A2, so that an attitude of the optical element 10 can be corrected about each of the first swing axis A1 and the second swing axis A2. Consequently, the image blur can be prevented in two directions. As a result, correction accuracy can be improved as compared with the case in which the optical element 10 is swung about only one swing axis. The first swing axis A1 is also referred to as a pitching axis. The second swing axis A2 is also referred to as a roll axis.

In the embodiment, as described above, the first support 30 supports the holder 20 and the optical element 10. The first support 30 is supported by the second support 60. That is, the holder 20 and the optical element 10 are indirectly supported by the second support 60 of the support body 3 through the first support 30. The holder 20 and the optical element 10 may be directly supported by the second support 60 of the support body 3 without the first support 30. That is, the movable body 2 may not include the first support 30.

The first swing axis A1 is an axis extending along the third direction Z intersecting the first direction X and the second direction Y. The second swing axis A2 is an axis extending along the first direction X. Accordingly, the optical element 10 can be swung about the first swing axis A1 intersecting the first direction X and the second direction Y. The optical element 10 can be swung about the second swing axis A2 extending along the first direction X. Consequently, the attitude of the optical element 10 can be appropriately corrected. The first direction X and the second direction Y are directions along the traveling direction of the light L (FIG. 5A). That is, the optical element 10 can be swung about the first swing axis A1 intersecting the first direction X and the second direction Y that are the traveling direction of the light L. Accordingly, the attitude of the optical element 10 can be corrected more appropriately.

The first support 30 supports the holder 20 in the third direction Z. Accordingly, the first support 30 can be easily swung about the first swing axis A1 extending along the third direction Z. Specifically, in the embodiment, the first support 30 supports the holder 20 in the third direction Z through the first preload unit 40.

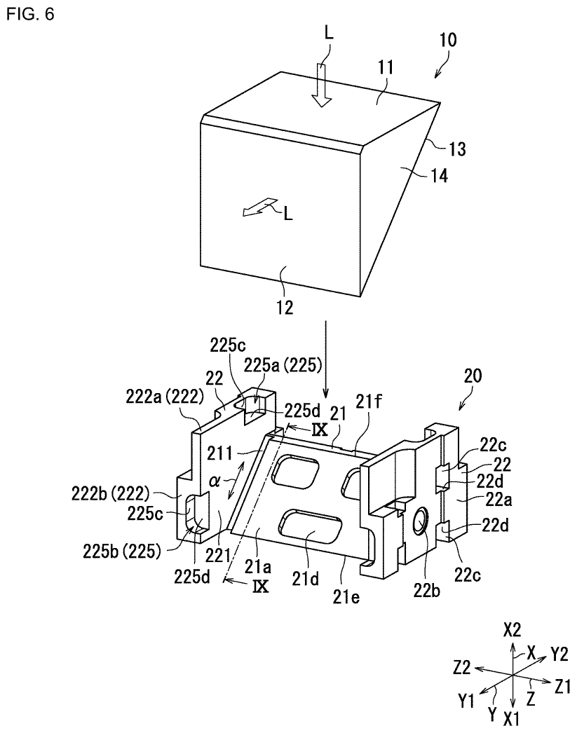

FIG. 5A is a sectional view taken along a line VA-VA in FIG. 2. FIG. 5B is a sectional view taken along a line VB-VB in FIG. 2. FIG. 5C is a sectional view taken along a line VC-VC in FIG. 2. FIG. 5D is a sectional view taken along a line VD-VD in FIG. 2. FIG. 6 is an exploded perspective view illustrating the optical element 10 and the holder 20 of the optical unit 1 of the embodiment. As illustrated in FIGS. 5A to 5D and 6, the optical element 10 is configured of a prism. The prism is made of a transparent material that has a higher refractive index than air. For example, the optical element 10 may be a plate-shaped mirror. In the embodiment, the optical element 10 has a substantially triangular prism shape. Specifically, the optical element 10 includes a light incident surface 11, a light emission surface 12, a reflection surface 13, and a pair of side surfaces 14. The light L is incident on the light incident surface 11. The light emission surface 12 is connected to the light incident surface 11. The light emission surface 12 is disposed perpendicular to the light incident surface 11. The reflection surface 13 is connected to the light incident surface 11 and the light emission surface 12. The reflection surface 13 is inclined by about 45 degrees with respect to each of the light incident surface 11 and the light emission surface 12. That is, the reflection surface 13 reflects the light L traveling to one side X1 in the first direction X to one side Y1 in the second direction Y intersecting the first direction X. That is, the optical element 10 reflects the light L traveling to one side X1 in the first direction X to one side Y1 in the second direction Y intersecting the first direction X. The pair of side surfaces 14 are connected to the light incident surface 11, the light emission surface 12, and the reflection surface 13. The pair of side surfaces 14 are disposed substantially perpendicular to the third direction Z. The reflection surface 13 is an example of the “mounted surface” of the present disclosure.

An optical axis L10 of the optical element 10 and the second swing axis A2 are disposed to overlap each other. In the present description, the optical axis L10 of the optical element 10 means an axis that coincides with at least any of an axis that is perpendicular to the light incident surface 11 of the optical element 10 and passes through the center of the reflection surface 13, a light axis of the lens 202 on which light is incident, an axis that passes through an intersection between the optical axis of the lens unit existing at the reflection destination and the reflection surface 13 and extends in the direction perpendicular to the optical axis of the lens unit, and an axis that passes through an intersection between a straight line passing through the center of the imaging element and the reflection surface 13 and extends in the direction perpendicular to a straight line passing through the imaging element. Typically, all the axis that is perpendicular to the light incident surface 11 of the optical element 10 and passes through the center of the reflection surface 13, the light axis of the lens 202 on which the light is incident, the axis that passes through an intersection between the optical axis of the lens unit present at the reflection destination and the reflection surface 13 and extends in the direction perpendicular to the optical axis of the lens unit, and the axis that passes through the intersection between the straight line passing through the center of the imaging element and the reflection surface 13 and extends in the direction perpendicular to the straight line passing through the imaging element coincide with one another.

For example, the holder 20 is made of resin. The holder 20 includes a holder body 21 and a side surface unit 22. In the embodiment, the holder 20 includes the holder body 21 and a pair of side surface units 22. The holder body 21 extends in the third direction Z, which intersects the first direction X and the second direction Y. The holder body 21 includes a support surface 21a. The support surface 21a is an example of the “mounting surface” of the present disclosure. The optical element 10 is mounted on the support surface 21a. The support surface 21a supports the optical element 10. The support surface 21a is a surface that faces the reflection surface 13 of the optical element 10 and is connected to the pair of side surface units 22. The support surface 21a is an inclination surface inclined by about 45 degrees with respect to the incident direction of the light L, and is in contact with the reflection surface 13 of the optical element 10 over substantially an entire area of the inclination surface. That is, the reflection surface 13 is mounted on the support surface 21a. The incident direction of the light L is a direction toward one side X1 in the first direction X.

The holder body 21 includes a back surface 21b and a lower surface 21c. The back surface 21b is connected to the support surface 21a at an end on the side opposite to the emission direction of the light L. The “emission direction of the light L” is one side Y1 in the second direction Y. The “end on the side opposite to the emission direction of the light L” is the end on the other side Y2 in the second direction Y. The lower surface 21c is connected to the support surface 21a and the back surface 21b.

The side surface unit 22 extends in an intersection direction (hereinafter referred to as an intersection direction) intersecting the third direction Z from the holder body 21. For example, the intersection direction includes the first direction X and the second direction Y. The pair of side surface units 22 are disposed at both ends of the holder body 21 in the third direction Z. The optical element 10 is disposed between the pair of side surface units 22. The pair of side surface units 22 has a shape symmetrical to each other in the third direction Z. An inner side surface 221 to be described later of the side surface unit 22 is connected to an end in the third direction Z of the support surface 21a.

At this point, the holder body 21 includes a groove 211 disposed at the end in the third direction Z of the support surface 21a. Alternatively, the optical element 10 includes a chamfer disposed at the connection unit of the reflection surface 13 and the side surface 14. In the embodiment, the case where the holder body 21 includes the groove 211 disposed at the end in the third direction Z of the support surface 21a will be described. An example in which the optical element 10 includes the chamfer disposed at the connection unit between the reflection surface 13 and the side surface 14 will be described later as a modification of the embodiment.

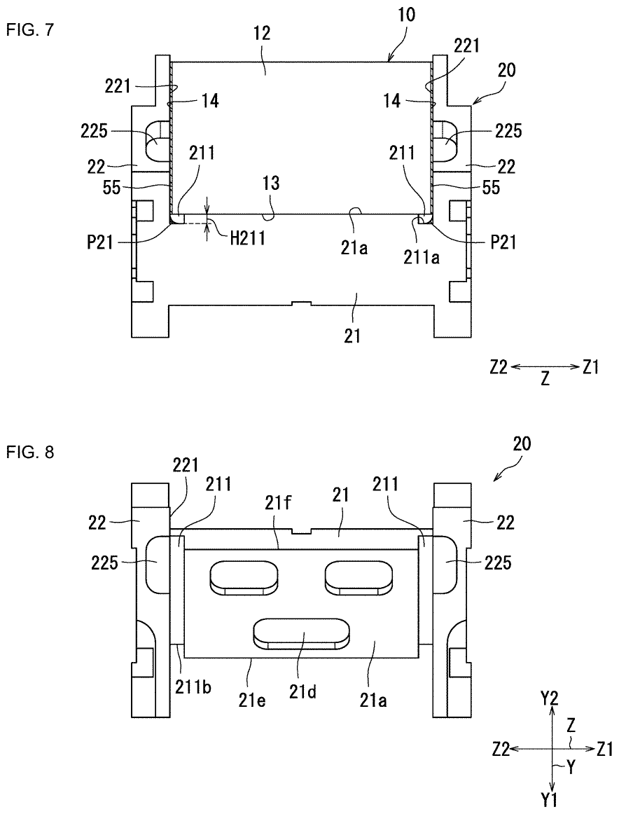

FIG. 7 is a view illustrating a structure of the optical element 10 and the holder 20 of the optical unit 1 of the embodiment as viewed from a fourth direction α. FIG. 8 is a view illustrating the structure of the holder 20 in the optical unit 1 of the embodiment from the first direction X. In FIG. 7, an unnecessary portion P21 and the second adhesive member 55 are hatched for easy understanding.

As illustrated in FIGS. 6 and 7, in the embodiment, as described above, the holder body 21 includes the groove 211 disposed at the end in the third direction Z of the support surface 21a. Accordingly, even when the corner of a holder molding metal mold (hereinafter, sometimes referred to as a metal mold) molding the holder 20 is eroded or the like to form the unnecessary portion P21 (see FIG. 7) having an R shape corresponding to the eroded portion or the like at the connection unit between the support surface 21a of the holder 20 and the inner side surface 221, the unnecessary portion P21 can be prevented from protruding from the groove 211 toward the side of the optical element 10. Consequently, the unnecessary portion P21 can be prevented from coming into contact with the optical element 10, so that the attachment accuracy of the optical element 10 with respect to the holder 20 can be prevented from being degraded. In the embodiment, the groove 211 is disposed at both ends in the third direction Z of the support surface 21a.

Unlike the case where the optical element 10 includes the chamfer disposed at the connection unit between the reflection surface 13 and the side surface 14, the holder body 21 includes the groove 211 disposed at the end in the third direction Z of the support surface 21a, so that the reflection surface 13 of the optical element 10 is not narrowed. In other words, when the chamfer is formed in the optical element 10, the optical element 10 needs to be enlarged by the amount of forming the chamfer. In addition, the groove 211 is also formed when the holder 20 is manufactured by the injection molding, additional processing (cutting processing or the like) forming the groove 211 on the holder 20 is not required. When the chamfer is formed in the optical element 10, additional chamfering is required to be performed on the commercially available optical element 10.

In the embodiment, a depth H211 of the groove 211 is deepest at the position closest to the inner side surface 221. Accordingly, the position of the groove 211 corresponding to the portion of the metal mold that is most likely to be damaged by the erosion or the like can be deepened. Consequently, even when the corner of the metal mold is damaged by the erosion or the like, the unnecessary portion P21 can be easily prevented from protruding toward the side of the optical element 10 from the support surface 21a.

In the embodiment, the depth H211 of the groove 211 is substantially constant. Specifically, the groove 211 includes a bottom surface 211a. The bottom surface 211a is substantially parallel to the support surface 21a.

The support surface 21a is connected to the inner side surface 221 along a fourth direction α (see FIG. 6) intersecting the third direction Z. The groove 211 extends from one end 21e to the other end 21f in the fourth direction α of the support surface 21a. Accordingly, even when the reflection surface 13 of the optical element 10 is larger than the support surface 21a in the fourth direction α, the optical element 10 can be easily prevented from contacting the unnecessary portion P21. The fourth direction α is a direction along the inclination direction of the support surface 21a.

As illustrated in FIG. 8, when viewed from the first direction X, the end 211b on one side Y1 in the second direction Y of the groove 211 is located on the other side Y2 in the second direction Y as compared with the end (one end 21e) on one side Y1 in the second direction Y of the support surface 21a. Accordingly, the end (end 211b) on the one side X1 in the first direction X of the groove 211 and the end (one end 21e) on the one side X1 in the first direction X of the support surface 21a can be easily located at the same position in the first direction X. That is, the end 211b of the groove 211 can be easily prevented from protruding from the lower surface 21c of the holder body 21 toward one side X1 in the first direction X. Consequently, complicated processing is not required to be performed on the lower mold of the metal mold because the lower mold of the holder molding metal mold can be flattened. Alternatively, a thickness for forming the groove 211 is not required to be secured on one side X1 in the first direction X with respect to the end (one end 21e) of the support surface 21a of the holder 20. In other words, an increase in the thickness of the holder 20 in the first direction X is not required.

The holder body 21 includes a recess 21d disposed on the support surface 21a. In the embodiment the holder body 21 includes three recesses 21d.

At this point, the recess 21d is disposed between the grooves 211 in the third direction Z. Alternatively, the recess 21d is disposed between the chamfers to be described later in the third direction Z. In the embodiment, the case where the recess 21d is disposed between the grooves 211 in the third direction Z will be described. An example in which the recess 21d is disposed between the chamfers in the third direction Z will be described later as a modification of the embodiment.

As described above, in the embodiment, the recess 21d is disposed between the grooves 211 in the third direction Z. Accordingly, a decrease in flatness of the support surface 21a excluding the recess 21d can be prevented because an area of the support surface 21a excluding the recess 21d is narrowed. Consequently, a variation in an attachment angle of the optical element 10 with respect to the support surface 21a can be prevented. The recess 21d is disposed at a predetermined distance from one end 21e and the other end 21f in the fourth direction α of the support surface 21a.

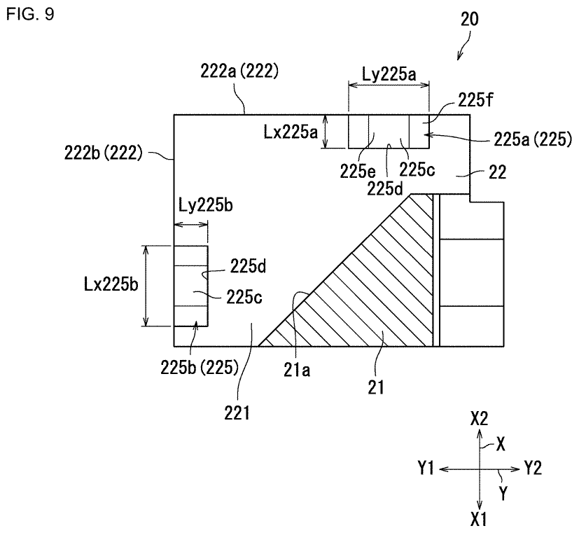

FIG. 9 is a sectional view taken along a line IX-IX in FIG. 6. As illustrated in FIGS. 6 and 9, the side surface unit 22 includes the inner side surface 221, an end surface 222, and a recess 225. In the embodiment, both of the pair of side surface units 22 include the inner side surface 221, the end surface 222, and the recess 225.

The inner side surface 221 faces the optical element 10. Specifically, the inner side surface 221 extends substantially parallel to the side surface 14 of the optical element 10. The side surface 14 of the optical element 10 faces the inner side surface 221. For example, the gap between the inner side surface 221 and the side surface 14 of the optical element 10 is less than or equal to several millimeters. In the embodiment, for example, the gap between the inner side surface 221 and the side surface 14 of the optical element 10 is less than or equal to 1 mm.

The end surface 222 is connected to an edge of the intersection direction of the inner side surface 221. The end surface 222 extends in the third direction Z. In the embodiment, the end surface 222 includes a first end surface 222a and a second end surface 222b. The first end surface 222a is connected to the edge in the first direction X of the inner side surface 221. The second end surface 222b is connected to the edge in the second direction Y of the inner side surface 221. More specifically, the first end surface 222a is connected to the edge on the other side X2 in the first direction X of the inner side surface 221. The second end surface 222b is connected to the edge on one side Y1 in the second direction Y of the inner side surface 221. In other words, the side surface unit 22 includes the first end surface 222a that is the end surface 222 disposed on the other side X2 in the first direction X and the second end surface 222b that is the end surface 222 disposed on one side Y1 in the second direction Y. The first end surface 222a extends in the second direction Y and the third direction Z. The second end surface 222b extends in the first direction X and the third direction Z.

The recess 225 is disposed astride the inner side surface 221 and the end surface 222. The recess 225 is recessed toward the intersection direction from the end surface 222. The recess 225 includes an inner surface 225c and a bottom surface 225d. The inner surface 225c extends toward the intersection direction with respect to the end surface 222. The inner surface 225c extends toward the intersection direction from the end surface 222. The bottom surface 225d intersects the inner surface 225c. In the embodiment, the recess 225 includes a first recess 225a and a second recess 225b. The first recess 225a is disposed astride the inner side surface 221 and the first end surface 222a. The first recess 225a is recessed along the first direction X from the first end surface 222a. The second recess 225b is disposed astride the inner side surface 221 and the second end surface 222b. The second recess 225b is recessed along the second direction Y from the second end surface 222b.

The recess 225 accommodates a first adhesive member 50 (see FIG. 2) that bonds the optical element 10 with the holder 20. The first adhesive member 50 comes into contact with the side surface 14 of the optical element 10 while being accommodated in the recess 225 of the holder 20.

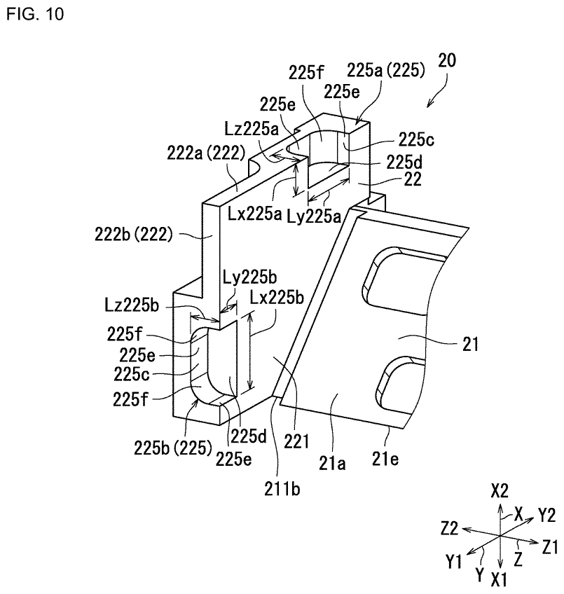

FIG. 10 is an enlarged perspective view illustrating the side surface unit 22 of the holder 20 in the optical unit 1 of the embodiment. As illustrated in FIGS. 9 and 10, the length of the recess 225 in the direction along the end surface 222 is larger than the depth in the intersection direction of the recess 225. Specifically, a length Ly225a in the second direction Y of the first recess 225a is larger than a depth Lx225a in the first direction X of the first recess 225a. In the embodiment, the length Ly225a is greater than or equal to twice the depth Lx225a. A length Lz225a in the third direction Z of the first recess 225a is substantially the same as the depth Lx225a in the first direction X of the first recess 225a.

A length Lx225b in the first direction X of the second recess 225b is larger than a depth Ly225b in the second direction Y of the second recess 225b. In the embodiment, the length Lx225b is greater than or equal to twice the depth Ly225b. A length Lz225b in the third direction Z of the second recess 225b is substantially the same as the depth Ly225b in the second direction Y of the second recess 225b.

In the optical unit 1 of the embodiment, as described above, the length of the recess 225 in the direction along the end surface 222 is greater than the depth in the intersection direction of the recess 225. Accordingly, an opening in the end surface 222 can be secured, so that the first adhesive member 50 can be easily injected. As a result, for example, when the first adhesive member 50 is injected into the recess 225, a needle (not illustrated) injecting the first adhesive member 50 can be prevented from coming into contact with the opening. Specifically, the needle can be prevented from coming into contact with the edge of the recess 225 and the edge of the optical element 10. For example, the needle having a larger diameter can be used. As a result, time needs to inject the first adhesive member 50 can be shortened.

As described above, both of the pair of side surface units 22 include the recess 225. Accordingly, adhesive force can be improved because the optical element 10 can be fixed to the pair of side surface units 22.

As described above, the recess 225 of the side surface unit 22 includes the first recess 225a and the second recess 225b. Accordingly, the adhesive force can be further improved because the optical element 10 can be fixed using the first recess 225a and the second recess 225b.

With reference to FIGS. 9 and 10, the side surface unit 22 will be described. The first recess 225a is disposed on the other side Y2 in the second direction Y of the first end surface 222a. The second recess 225b is disposed on one side X1 in the first direction X of the second end surface 222b. Accordingly, two of the optical elements 10 that are far from each other can be fixed to the holder 20. As a result, the optical element 10 can be stably fixed to the holder 20.

For example, the first adhesive member 50 is an ultraviolet curable adhesive. Accordingly, when the first adhesive member 50 is cured in the recess 225, the first adhesive member 50 is required to be irradiated with an ultraviolet ray. In the embodiment, as described above, the length of the recess 225 in the direction along the end surface 222 is larger than the depth in the intersection direction of the recess 225. Consequently, it is easy to irradiate the first adhesive member 50 is easily irradiated with the ultraviolet ray. The ultraviolet ray can easily reach the bottom surface 225d of the recess 225 because the depth of the recess 225 can be reduced. The first adhesive member 50 is not particularly limited, but for example, may be a thermosetting adhesive.

The inner surface 225c of the recess 225 includes a curved surface that is curved as viewed from the optical axis direction of the optical element 10. Accordingly, for example, when the holder 20 is molded by the injection molding, the metal mold component can be easily removed from the recess 225. That is, the holder 20 can be easily molded. For example, in the case where the first adhesive member 50 in the recess 225 is irradiated with the ultraviolet ray, the light hardly reaches the corners where the flat surfaces intersect each other when the inner surface 225c of the recess 225 is formed only by flat surfaces. However, in the embodiment, the inner surface 225c of the recess 225 has a curved surface that is curved as viewed from the optical axis direction of the optical element 10, so that generation of a part that the light hardly reaches can be prevented.

Specifically, the inner surface 225c of the recess 225 includes a plurality of flat surfaces 225e and a curved surfaces 225f. In the embodiment, the inner surface 225c includes three flat surfaces 225e and two curved surfaces 225f. The flat surfaces 225e are connected to each other by the curved surface 225f. That is, the flat surfaces 225e are not directly connected to each other.

The bottom surface 225d of the recess 225 extends in the direction along the end surface 222. Accordingly, the depth from the surface of the first adhesive member 50 to the bottom surface 225d can be prevented from becoming non-uniform. As a result, the first adhesive member 50 can be easily and uniformly cured. In the embodiment, the depth of the bottom surface 225d is substantially constant. The bottom surface 225d is substantially parallel to the end surface 222. Specifically, the bottom surface 225d of the first recess 225a is substantially parallel to the first end surface 222a. The bottom surface 225d of the second recess 225b is substantially parallel to the second end surface 222b.

The second adhesive member 55 (see FIG. 5B) is disposed between the inner side surface 221 and the optical element 10. Accordingly, the second adhesive member 55 can firmly fix the optical element 10 and the holder 20. The second adhesive member 55 is an example of the “adhesive member” of the present disclosure. For example, the second adhesive member 55 is a thermosetting adhesive. Using the ultraviolet curable adhesive (first adhesive member 50) and the thermosetting adhesive (second adhesive member 55) together, for example, the optical element 10 and the holder 20 can be handled while only the ultraviolet curable adhesive is cured to temporarily fix the optical element 10 to the holder 20. The second adhesive member 55 is not particularly limited, but for example, may be an ultraviolet curable adhesive.

As described above, the second adhesive member 55 is disposed between the side surface unit 22 of the holder 20 and the optical element 10. The second adhesive member 55 bonds the holder 20 and the optical element 10. Accordingly, the optical element 10 can be easily fixed to the holder 20.

Subsequently, the structure of the side surface unit 22 will be described. As illustrated in FIGS. 5A to 5D and 6, at least one of the holder 20 and the first support 30 includes a recess recessed on the side opposite to the first preload unit 40 or a protrusion protruding toward the first preload unit 40. In the embodiment, the holder 20 includes an axial recess 22b that is recessed on the side opposite to the first preload unit 40.

Specifically, the holder 20 includes a pair of opposing side surfaces 22a and the axial recess 22b. The pair of opposing side surfaces 22a are disposed on the pair of side surface units 22. The pair of opposing side surfaces 22a is opposite to a pair of the first preload units 40. A detailed structure of the first preload unit 40 will be described later. The axial recess 22b is disposed on the opposing side surface 22a. The axial recess 22b is recessed toward an inside of the holder 20 on the first swing axis A1. The axial recess 22b accommodates at least a part of an axial protrusion 45 of the first preload unit 40. The axial recess 22b includes at least a part of a recessed spherical surface.

One of the holder 20 and the first support 30 includes a restriction recess 22c. The restriction recess 22c restricts a protrusion 46 of the first preload unit 40 from moving in the direction intersecting the first swing axis A1.

In the embodiment, the holder 20 includes the restriction recess 22c. Specifically, the restriction recess 22c is disposed in the opposing side surface 22a. The restriction recess 22c restricts the first preload unit 40 from moving by at least a predetermined distance along the side surface unit 22. More specifically, the restriction recess 22c is recessed toward the inside of the holder 20 in the third direction Z. The restriction recess 22c includes an inner surface 22d. For example, the restriction recess 22c may be a recess in which both sides in the first direction X and both sides in the second direction Y are closed. For example, the restriction recess 22c may be a recess in which one side in the first direction X is opened or a recess in which one side in the second direction Y is opened.

The protrusion 46 of the first preload unit 40 is disposed in the restriction recess 22c. The protrusion 46 of the first preload unit 40 is separated from the inner surface 22d of the restriction recess 22c at a predetermined distance while the axial protrusion 45 is fitted in the axial recess 22b. On the other hand, when impact or the like is applied to the optical unit 1 and when the holder 20 is about to move in the first direction X and the second direction Y by at least a predetermined distance, the protrusion 46 of the first preload unit 40 comes into contact with the inner surface 22d of the restriction recess 22c. Accordingly, the holder 20 can be prevented from coming off from the first preload unit 40. In the embodiment, for example, four restriction recesses 22c are provided. The number of the restriction recesses 22c may be one, but preferably a plurality of restriction recesses 22c are provided.

The optical unit 1 includes the first preload unit 40. The first preload unit 40 connects the holder 20 and the first support 30. The first preload unit 40 is elastically deformable. The first preload unit 40 is disposed on at least one of the holder 20 and the first support 30. The first preload unit 40 applies a preload to at least the other of the holder 20 and the first support 30 in the axial direction of the first swing axis A1. Accordingly, the holder 20 can be prevented from displacing in the axial direction of the first swing axis A1 with respect to the first support 30. Even when a manufacturing error is generated in dimensions of each member, rattling or the like can be prevented from being generated in the axial direction of the first swing axis A1. In other words, for example, the position of the holder 20 can be prevented from being displaced in the axial direction of the first swing axis A1. The axial direction of the first swing axis A1 is a direction along the third direction Z. In the present description, “applying preload” means previously applying a load.

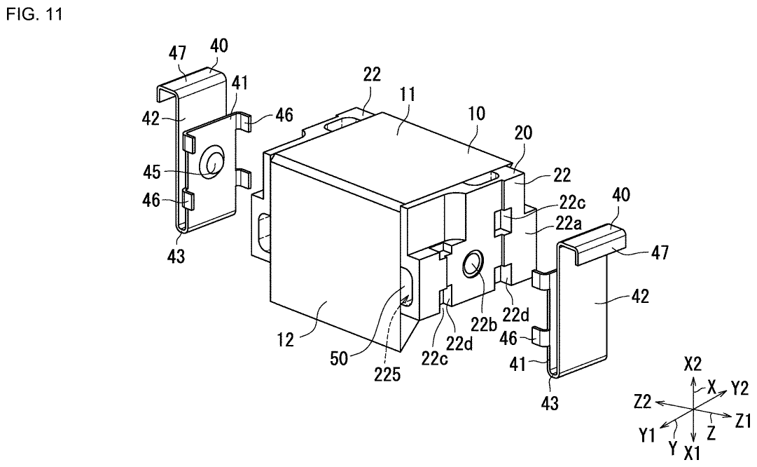

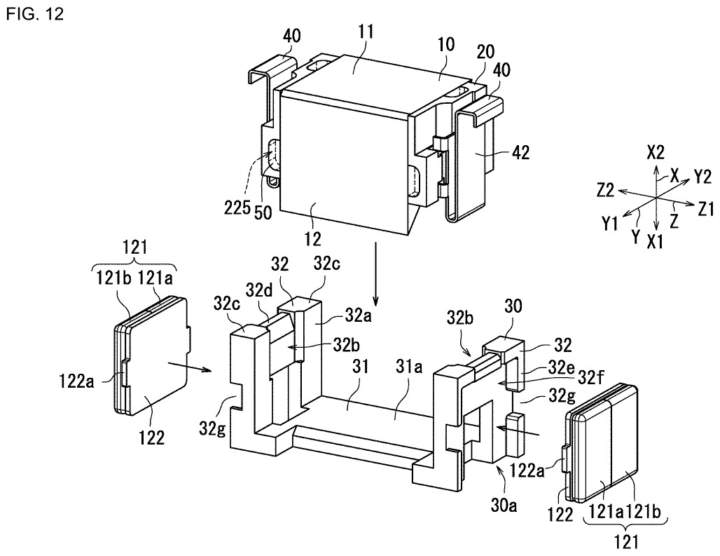

With reference to FIGS. 11 and 12, the detailed structure of the first preload unit 40 will be described below. FIG. 11 is an exploded perspective view illustrating the optical element 10, the holder 20, and the first preload unit 40 of the optical unit 1 of the embodiment. FIG. 12 is an exploded perspective view illustrating the optical element 10, the holder 20, the first preload unit 40, the first support 30, and a second magnet 121 of the optical unit 1 of the embodiment. As illustrated in FIGS. 11 and 12, the first preload unit 40 is disposed between the holder 20 and the first support 30. The first preload unit 40 applies the preload to the holder 20 in the axial direction of the first swing axis A1.

Specifically, in the embodiment, each first preload unit 40 is a single member. The first preload unit 40 is formed by bending one plate member. In the embodiment the first preload unit 40 is a plate spring. The first preload unit 40 is disposed on the first support 30.

The first preload unit 40 includes a first surface 41 located on the side of the holder 20, a second surface 42 located on the side of the first support 30, and a curved unit 43 connecting the first surface 41 and the second surface 42. Accordingly, the first preload unit 40 can be easily deformed in the axial direction of the first swing axis A1. As a result, elastic force is generated due to the bending of the curved unit 43, so that the preload can be easily applied to the holder 20 in the axial direction with a simple configuration.

Specifically, the first surface 41 is opposite to the holder 20 in the axial direction of the first swing axis A1. The first surface 41 is opposite to the side surface unit 22 of the holder 20. The first surface 41 extends along the first direction X and the second direction Y. The first surface 41 is disposed along the side surface unit 22. The second surface 42 is opposite to the first support 30 in the axial direction of the first swing axis A1. The second surface 42 is opposite to the side surface unit 32 of the first support 30. The second surface 42 extends along the first direction X and the second direction Y. The second surface 42 is disposed along the side surface unit 32.

The curved unit 43 is elastically deformable. Consequently, the first surface 41 and the second surface 42 can move in a direction where the first surface 41 and the second surface 42 approach or separate from each other. In the embodiment, the first preload unit 40 is compressed and deformed in the axial direction of the first swing axis A1 such that the first surface 41 and the second surface 42 approach each other while the first preload unit 40 is disposed between the holder 20 and the first support 30. Accordingly, the first preload unit 40 applies the preload to the holder 20 by reaction force according to a deformation amount.

The first preload unit 40 includes a protrusion protruding toward at least one of the holder 20 and the first support 30 or a recess recessed on the side opposite to at least one of the holder 20 and the first support 30. The protrusion or the recess of the first preload unit 40 comes into contact with the protrusion or the recess of at least one of the holder 20 and the first support 30. In the embodiment, the first preload unit 40 includes the axial protrusion 45. The axial protrusion 45 protrudes toward the holder 20. The axial protrusion 45 of the first preload unit 40 comes into contact with the axial recess 22b of the holder 20.

In the embodiment, the axial protrusion 45 is disposed on the first surface 41. The axial protrusion 45 protrudes toward the holder 20 on the first swing axis A1. The axial protrusion 45 has at least a part of a spherical surface. A part of the axial protrusion 45 is accommodated in the axial recess 22b. Accordingly, the axial protrusion 45 and the axial recess 22b are in point contact with each other, so that the first preload unit 40 can stably support the holder 20.

In the embodiment, a pair of first preload units 40 is provided. That is, the optical unit 1 includes the pair of first preload units 40. The pair of first preload units 40 is disposed on both sides of the first swing axis A1 in the axial direction with respect to the holder 20. Accordingly, the holder 20 can be supported more stably as compared with the case where the first preload unit 40 is disposed only on one side of the holder 20.

Specifically, the axial protrusions 45 of the pair of first preload units 40 come into contact with the pair of axial recesses 22b of the holder 20. The holder 20 is supported by the first preload unit 40 from both sides in the axial direction of the first swing axis A1 at two contact points in contact with the axial protrusion 45. Accordingly, the holder 20 can swing about the first swing axis A1 passing through the two contact points.

The first preload unit 40 further includes the protrusion 46. The protrusion 46 is disposed on one of the first surface 41 and the second surface 42, and protrudes toward one of the holder 20 and the first support 30. In the embodiment, the protrusion 46 is disposed on the first surface 41 similarly to the axial protrusion 45. The protrusion 46 protrudes toward the holder 20 in the direction along the first swing axis A1. The protrusion 46 is provided corresponding to the restriction recess 22c. For example, four protrusions 46 are provided in each first preload unit 40. A part of the protrusion 46 is accommodated in the restriction recess 22c. The protrusion 46 is disposed so as to surround the axial protrusion 45. In other words, the axial protrusion 45 is disposed inside a region containing the four protrusions 46. For example, the number of protrusions 46 may be 1 to 3, or at least 5. The protrusion 46 is formed by bending the end of the first surface 41.

The first preload unit 40 includes an attachment unit 47. For example, the attachment unit 47 is disposed on the second surface 42. The attachment unit 47 is disposed at the upper end of the second surface 42. The attachment unit 47 is attached on the upper end of the side surface unit 32 of the first support 30. For example, the attachment unit 47 is attached to the side surface unit 32 by pinching the upper end of the side surface unit 32 in the first direction X. The first preload unit 40 needs not to include the attachment unit 47, and for example, may be fixed to the first support 30 using an adhesive or the like. In the embodiment, the attachment unit 47 is fixed to the first support 30 using an adhesive.

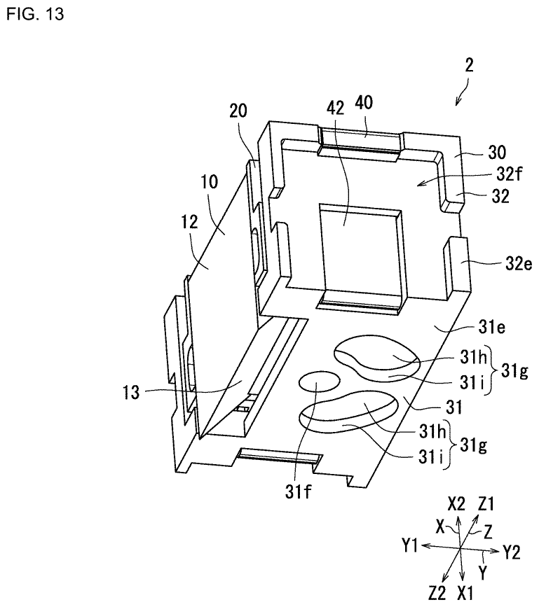

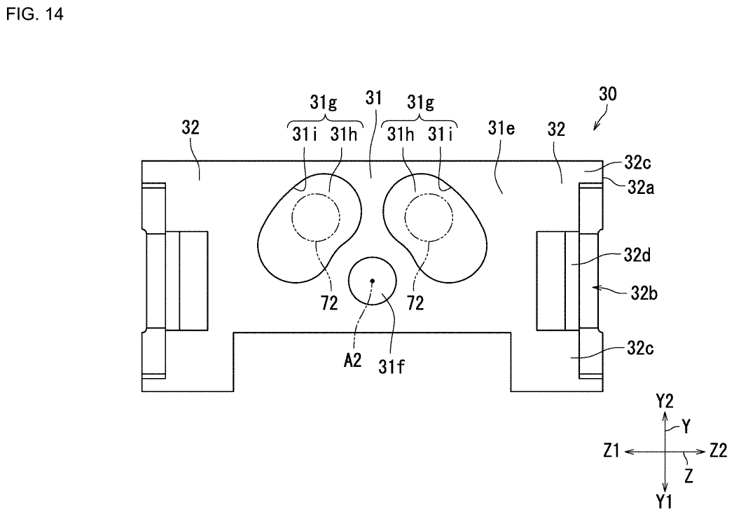

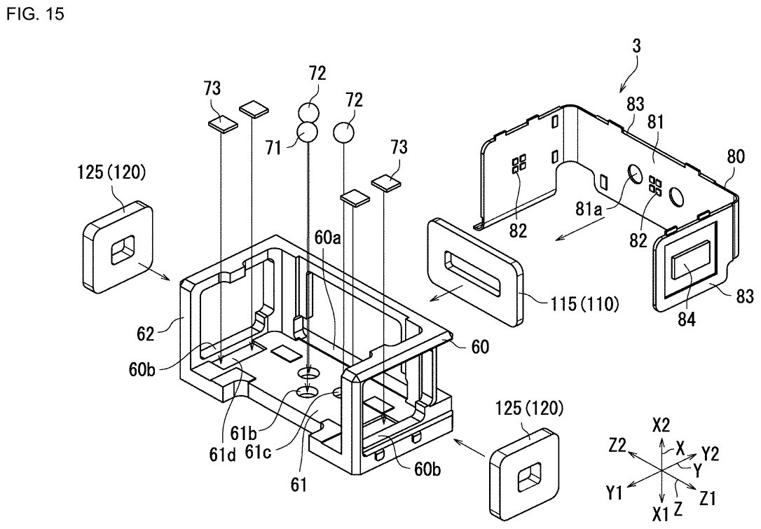

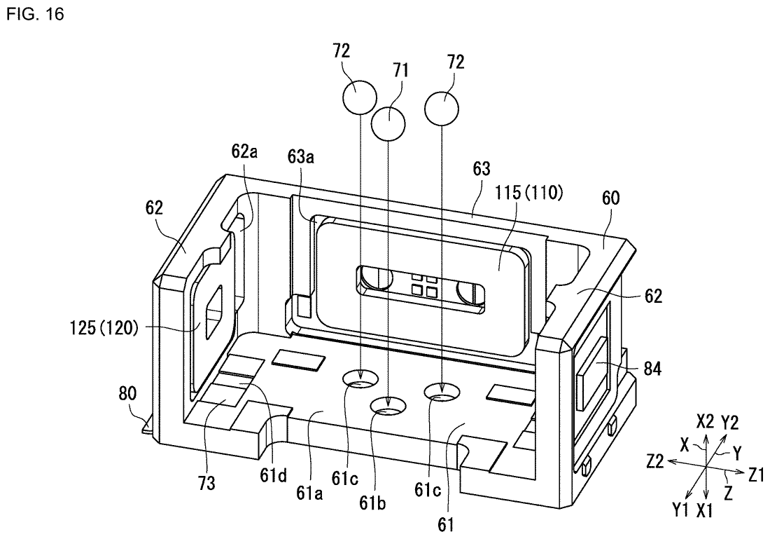

FIG. 13 is a perspective view illustrating the movable body 2 of the optical unit 1 of the embodiment. FIG. 14 is a view illustrating the first support 30 of the optical unit 1 of the embodiment as viewed from one side X1 in the first direction X. FIG. 15 is an exploded perspective view illustrating the support body 3 of the optical unit 1 of the embodiment. FIG. 16 is a perspective view illustrating a periphery of the second support 60 in the optical unit 1 of the embodiment.

As illustrated in FIGS. 13 to 16, one of the movable body 2 and the support body 3 includes a first protrusion 71 protruding toward the other of the movable body 2 and the support body 3. Specifically, one of the first support 30 and the second support 60 includes the first protrusion 71 protruding toward the other of the first support 30 and the second support 60. The other of the movable body 2 and the support body 3 comes into contact with the first protrusion 71. The first protrusion 71 is disposed on the second swing axis A2. Accordingly, the movable body 2 swings about the first protrusion 71. Consequently, the length from the contact position between the movable body 2 and the support body 3 to the swing center can be reduced. Because the force required to swing the movable body 2 is a product of the length from the contact position to the swing center and frictional force, the force required to swing the movable body 2 can be reduced by disposing the first protrusion 71 on the second swing axis A2. That is, the force required to drive the optical unit 1 can be reduced. The material of the first protrusion 71 is not particularly limited, but for example, the first protrusion 71 is formed of ceramic, resin, or metal.

The first protrusion 71 is disposed on the second swing axis A2, so that the contact position between the movable body 2 and the support body 3 does not move with respect to the first protrusion 71. Accordingly, the frictional force between the other of the movable body 2 and the support body 3 and the first protrusion 71 can be reduced, for example, as compared with the case where the other of the movable body 2 and the support body 3 swings with respect to the first protrusion 71 when the movable body 2 swings. The optical axis L10 and the second swing axis A2 are disposed to overlap each other, so that the optical axis L10 can be prevented from deviating from the second swing axis A2 when the movable body 2 is swung.

In the embodiment, the support body 3 includes the first protrusion 71. Accordingly, the first protrusion 71 can be prevented from rotating when the movable body 2 swings. Consequently, the movable body 2 can be stably supported by the first protrusion 71. As a result, the swing of the movable body 2 is stabilized.

One of the movable body 2 and the support body 3 includes a plurality of second protrusions 72 protruding toward the other of the movable body 2 and the support body 3. Specifically, one of the first support 30 and the second support 60 includes the plurality of second protrusions 72 protruding toward the other of the first support 30 and the second support 60. The plurality of second protrusions 72 are disposed at positions separated from the second swing axis A2. The other of the movable body 2 and the support body 3 comes into contact with the plurality of second protrusions 72. The first protrusion 71 and the plurality of second protrusions 72 are disposed on the same plane intersecting the second swing axis A2. Accordingly, the movable body 2 can be supported by the first protrusion 71 and the plurality of second protrusions 72 disposed on the same plane. As a result, the movable body 2 can be stably supported. Examples of the same plane on which the first protrusion 71 and the plurality of second protrusions 72 are disposed include a plane including an opposing surface 61a and a plane including a lower opposing surface 31e. The material of the second protrusion 72 is not particularly limited, but for example, the second protrusion 72 is formed of ceramic, resin, or metal.

The position of the second protrusion 72 is constant. In other words, the second protrusion 72 does not move with respect to one of the movable body 2 and the support body 3. In the embodiment, the second protrusion 72 does not move with respect to the support body 3. In other words, in the embodiment, the position of the second protrusion 72 with respect to the support body 3 is constant even when the movable body 2 swings. Accordingly, the movable body 2 can be supported more stably.

In the embodiment, the number of second protrusions 72 is two. Accordingly, the movable body 2 is supported by three protrusions (first protrusion 71 and second protrusions 72), so that the movable body 2 can be supported more stably as compared with the case where the movable body 2 is supported by at least four protrusions. In the embodiment, the movable body 2 is in point contact at three points, so that the movable body 2 can be supported more stably.

The other of the movable body 2 and the support body 3 includes a first recess 31f recessed in the direction opposite to the first protrusion 71. The first recess 31f comes into contact with the first protrusion 71. Accordingly, the center of the first protrusion 71 can be prevented from deviating from the center axis of the first recess 31f by receiving the first protrusion 71 at the first recess 31f having the recessed shape. As a result, the image blur due to deviation of the center of rotation can be prevented. The swing of the movable body 2 can be prevented from becoming unstable due to the deviation of the rotation center. As a result, for example, the current value required to swing can be prevented from fluctuating.

In the embodiment, the movable body 2 includes the first recess 31f, and the support body 3 includes the first protrusion 71. Accordingly, when the first protrusion 71 has the sphere, the movable body 2 can be assembled to the support body 3 while the sphere is disposed on the second support 60, so that the assembly work can be facilitated.

With reference to FIGS. 12 and 13, the structure around the first support 30 will be described in detail below. As illustrated in FIGS. 12 and 13, the first support 30 includes a support main body 31 and a pair of side surface units 32. The pair of side surface units 32 is disposed on both sides of the holder 20 in the axial direction of the first swing axis A1. The support main body 31 connects the pair of side surface units 32.

The support main body 31 includes an upper opposing surface 31a. The upper opposing surface 31a is opposite to the holder 20 in the first direction X. The upper opposing surface 31a is separated from the bottom surface of the holder 20.

The pair of side surface units 32 is disposed at both ends of the support main body 31 in the third direction Z. The pair of side surface units 32 has the shapes symmetrical to each other in the third direction Z. The side surface unit 32 includes an inner side surface 32a. The inner side surface 32a is opposite to the holder 20 in the third direction Z.

One of the first support 30 and the holder 20 includes an attachment groove 32b. The attachment groove 32b is recessed toward the side opposite to the other of the first support 30 and the holder 20 on the first swing axis A1. Accordingly, the holder 20 and the first preload unit 40 can be easily attached to the first support 30 by moving the first preload unit 40 along the attachment groove 32b. In the embodiment, the first support 30 includes the attachment groove 32b. The attachment groove 32b is recessed toward the side opposite to the holder 20 on the first swing axis A1. The attachment groove 32b accommodates at least a part of the first preload unit 40, and extends in the direction intersecting the first swing axis A1.

In the embodiment, the attachment groove 32b is disposed in the inner side surface 32a. The attachment groove 32b accommodates a part of the first preload unit 40. The attachment groove 32b extends in the first direction X.

Each side surface unit 32 includes a pair of columns 32c and a connection unit 32d. The pair of columns 32c is separated from each other in the second direction Y. The column 32c extends in the first direction X. The connection unit 32d connects upper portions of the columns 32c to each other. The length of the connection unit 32d in the third direction Z is shorter than the length of the column 32c in the third direction Z. The attachment groove 32b is formed by the pair of columns 32c and the connection unit 32d.

The first preload unit 40 can move along the attachment groove 32b. In the embodiment, the first preload unit 40 can move in the first direction X along the attachment groove 32b. The attachment unit 47 of the first preload unit 40 pinches the connection unit 32d in the third direction Z by moving the first preload unit 40 along the attachment groove 32b.

The side surface unit 32 includes an outer side surface 32e and an accommodation recess 32f. The outer side surface 32e faces the outside of the third direction Z. The accommodation recess 32f is disposed on the outer side surface 32e. The accommodation recess 32f accommodates at least a part of second magnets 121 of the second swing mechanism 120. The side surface unit 32 includes a pair of notches 32g. The notch 32g is disposed at the end in the second direction Y of the accommodation recess 32f. A projection 122a of a magnet support plate 122 is disposed in the notch 32g. The magnet support plate 122 supports the second magnet 121. The notch 32g supports the magnet support plate 122. The material of the magnet support plate 122 is not particularly limited, but for example, a magnetic material may be used. In this case, the magnet support plate 122 is also called a back yoke. Magnetic leakage can be prevented using the magnet support plate 122 made of a magnetic material.

The other of the movable body 2 and the support body 3 includes a second recess 31g. In the embodiment, the movable body 2 includes the second recess 31g. Specifically, the support main body 31 includes the lower opposing surface 31e, the first recess 31f, and the second recess 31g. The lower opposing surface 31e is opposite to the support body 3 in the first direction X. The first recess 31f and the second recess 31g are disposed on the lower opposing surface 31e.

The first recess 31f is disposed on the second swing axis A2. The first recess 31f has a part of a recessed spherical surface. Accordingly, because the first protrusion 71 is received by the recessed spherical surface, for example, the first protrusion 71 is less likely to laterally deviate in the first recess 31f. As a result, the movable body 2 can be stably supported. On the other hand, for example, when the first recess 31f has a rectangular cross section, the first protrusion 71 tends to laterally deviate with respect to the first recess 31f. In the embodiment, for example, unlike the case where the first protrusion 71 and the first recess 31f have the rectangular cross section, the first protrusion 71 and the first recess 31f can be easily brought into point contact.

The second recess 31g is recessed in the direction opposite to the second protrusion 72. The second recess 31g is separated from the first recess 31f. That is, the second recess 31g is separated from the second swing axis A2. A plurality of second recesses 31g are provided. In the embodiment, two second recesses 31g are provided. The two second recesses 31g are disposed at equal distances to the second swing axis A2. The second recess 31g includes a sliding surface 31h and an inner side surface 31i.

The second recess 31g comes into contact with the second protrusion 72. Specifically, the sliding surface 31h of the second recess 31g comes into contact with the second protrusion 72. The sliding surface 31h is disposed substantially parallel to the lower opposing surface 31e. That is, a depth of the second recess 31g is substantially constant.

As illustrated in FIG. 14, the contour of the second recess 31g is disposed outside the second protrusion 72 as viewed from the optical axis direction. Accordingly, the second protrusion 72 can be prevented from coming into contact with the inner side surface 31i of the second recess 31g. As a result, friction between the second protrusion 72 and the second recess 31g can be prevented. Specifically, the inner side surface 31i surrounds the sliding surface 31h. The inner side surface 31i is separated from the second protrusion 72. That is, as viewed from the optical axis direction, the contour of the second recess 31g is separated with respect to the second protrusion 72. The inner side surface 31i is disposed at a position where the second protrusion 72 does not come into contact when the first support 30 is swung by the second swing mechanism 120 about the second swing axis A2. In the embodiment, two second recesses 31g are provided, but only one second recess 31g may be provided. That is, for example, one second recess larger than the second recess 31g may be provided, and two second protrusions 72 may be accommodated in the one second recess. In other words, the contour of the one second recess may be disposed outside the two second protrusions 72. However, the thickness of the first support 30 becomes thin in a region where the second recess is formed. For this reason, there is a possibility that the strength of the first support 30 decreases when one large second recess is provided. Accordingly, in the embodiment, the two second recesses 31g are provided in order to secure the thickness of the first support 30 in the region other than the movable region of the second protrusion 72. In other words, the second recess is formed while divided into two. Accordingly, the thickness of the first support 30 can be prevented from becoming thin between the two second recesses 31g. As a result, the strength of the first support 30 can be prevented from decreasing.

As illustrated in FIGS. 3 and 5A, the second protrusion 72 is disposed on the other side Y2 in the second direction Y relative to the first recess 31f. Accordingly, the second protrusion 72 can be prevented from coming into contact with the reflection surface 13 of the optical element 10. As a result, a space where the optical element 10 is disposed can be easily secured. The larger optical element 10 can also be mounted. Specifically, a part of the reflection surface 13 protrudes toward one side X1 in the first direction X and one side Y1 in the second direction Y with respect to the lower opposing surface 31e. Accordingly, the optical element 10 can be prevented from coming into contact with a part of the first support 30 where the second protrusion 72 is disposed. As a result, the space where the optical element 10 is disposed can be easily secured.

As illustrated in FIGS. 15 and 16, the support body 3 includes the second support 60, the first protrusion 71, the second protrusion 72, and a magnetic member 73. The support body 3 preferably includes the opposing surface 61a and a third accommodation recess 61d.

Specifically, the second support 60 supports the first support 30 while being swingable about the second swing axis A2 intersecting the first swing axis A1. The second support 60 supports the first support 30 in the first direction X.

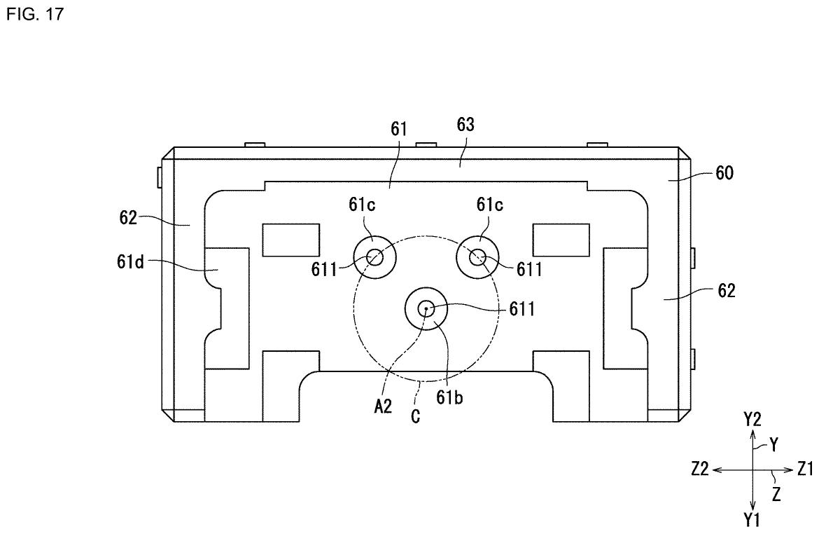

FIG. 17 is a view illustrating the second support of the optical unit of the embodiment as viewed from the other side X2 in the first direction X. As illustrated in FIGS. 15 to 17, the second support 60 includes a support main body 61, a pair of side surface units 62, and a back surface unit 63. The support main body 61 includes the opposing surface 61a, a first accommodation recess 61b, at least two second accommodation recesses 61c, and a plurality of third accommodation recesses 61d. In the embodiment, the support main body 61 includes one first accommodation recess 61b, two second accommodation recesses 61c, and two third accommodation recesses 61d. In the embodiment, an example in which the second support 60 includes the first accommodation recess 61b and the second accommodation recess 61c will be described. However, one of the movable body 2 and the support body 3 may include the first accommodation recess and the second accommodation recess that are recessed in the direction opposite to the other of the movable body 2 and the support body 3. For example, one of the movable body 2 and the support body 3 may include the first accommodation recess, and the other of the movable body 2 and the support body 3 may include the second accommodation recess.

The opposing surface 61a is opposite to the lower opposing surface 31e of the first support 30 in the first direction X. The first accommodation recess 61b, the second accommodation recess 61c, and the third accommodation recess 61d are disposed on the opposing surface 61a. The first accommodation recess 61b, the second accommodation recess 61c, and the third accommodation recess 61d are recessed toward the direction opposite to the movable body 2 in the first direction X. That is, the first accommodation recess 61b, the second accommodation recess 61c, and the third accommodation recess 61d are recessed toward one side X1 in the first direction X. The first accommodation recess 61b is opposite to the first recess 31f of the first support 30 in the first direction X. The first accommodation recess 61b is disposed on a same circumference C (see FIG. 17) about the second swing axis A2. The first accommodation recess 61b accommodates a part of the first protrusion 71. Accordingly, the first protrusion 71 is disposed on the second swing axis A2.

The second accommodation recess 61c is separated from the first accommodation recess 61b. Accordingly, the second accommodation recess 61c is separated from the second swing axis A2. In the embodiment, the second accommodation recess 61c is separated at a distance from the first accommodation recess 61b. The second accommodation recess 61c accommodates a part of the second protrusion 72. Accordingly, the plurality of second protrusions 72 are disposed on the same circumference C about the second swing axis A2. Accordingly, the movable body 2 can be supported at a position with an equal distance from the first protrusion 71. As a result, the movable body 2 can be supported more stably. The axial direction of the second swing axis A2 is the direction along the first direction X.

The two second accommodation recesses 61c are disposed at positions farther to the optical element 10 relative to the first accommodation recess 61b while arranged in the third direction Z.

The first accommodation recess 61b holds a part of the first protrusion 71. In the embodiment, the lower half of the first protrusion 71 is disposed in the first accommodation recess 61b. The first protrusion 71 includes at least a part of a spherical surface. Accordingly, the first protrusion 71 comes into point contact with the other of the movable body 2 and the support body 3, so that the frictional force between the first protrusion 71 and the other of the movable body 2 and the support body 3 can be reduced. In the embodiment, the first protrusion 71 comes into point contact with the movable body 2, so that the frictional force between the first protrusion 71 and the movable body 2 can be reduced.

In the embodiment, the first protrusion 71 is a sphere. Accordingly, the friction between the first protrusion 71 and the first recess 31f becomes rolling friction. As a result, an increase in the frictional force between the first protrusion 71 and the first recess 31f can be prevented. Specifically, the first protrusion 71 can rotate in the first accommodation recess 61b. Accordingly, the friction between the first protrusion 71 and the first recess 31f becomes the rolling friction. The first protrusion 71 may be fixed to the first recess 31f by using, for example, an adhesive.

The second accommodation recess 61c holds a part of the second protrusion 72. In the embodiment, the lower half of the second protrusion 72 is disposed in the second accommodation recess 61c. The second protrusion 72 includes at least a part of a spherical surface. Accordingly, the second protrusion 72 comes into point contact with the other of the movable body 2 and the support body 3, so that the frictional force between the second protrusion 72 and the other of the movable body 2 and the support body 3 can be reduced. In the embodiment, the second protrusion 72 is in point contact with the movable body 2, so that the frictional force between the second protrusion 72 and the movable body 2 can be reduced.

In the embodiment, the second protrusion 72 is a sphere. Accordingly, the friction between the second protrusion 72 and the other of the movable body 2 and the support body 3 becomes the rolling friction, so that the frictional force can be prevented. In the embodiment, the friction between the second protrusion 72 and the movable body 2 becomes the rolling friction. Specifically, the second protrusion 72 can rotate in the second accommodation recess 61c. Accordingly, the friction between the second protrusion 72 and the second recess 31g of the first support 30 becomes the rolling friction. The second protrusion 72 may be fixed to the second recess 31g by using, for example, an adhesive.

As illustrated in FIGS. 5C and 17, the first accommodation recess 61b may include a center recess 611. The center recess 611 is disposed on the same circumference with the first accommodation recess 61b. The first protrusion 71 comes into contact with the edge of the center recess 611. A diameter of the center recess 611 is smaller than a diameter of the first protrusion 71. Accordingly, for example, even when a gap is generated between the outer peripheral surface of the first protrusion 71 and the inner peripheral surface of the first accommodation recess 61b, the first protrusion 71 can be positioned by the center recess 611. That is, the center of the first protrusion 71 can be disposed on the center axis of the center recess 611. As a result, the center of the first protrusion 71 can be easily disposed on the center axis of the first accommodation recess 61b.

As illustrated in FIGS. 5D and 17, the second accommodation recess 61c may include the center recess 611. The center recess 611 is disposed on the same circumference with the second accommodation recess 61c. The second protrusion 72 comes into contact with the edge of the center recess 611. The diameter of the center recess 611 is smaller than the diameter of the second protrusion 72. Accordingly, for example, even when the gap is generated between the outer peripheral surface of the second protrusion 72 and the inner peripheral surface of the second accommodation recess 61c, the second protrusion 72 can be positioned by the center recess 611. That is, the center of the second protrusion 72 can be disposed on the center axis of the center recess 611. As a result, the center of the second protrusion 72 can be easily disposed on the center axis of the second accommodation recess 61c.

The materials of the first protrusion 71 and the second protrusion 72 are ceramic. Accordingly, it is possible to suppress the first protrusion 71 and the second protrusion 72 can be prevented from becoming worn. The materials of the first protrusion 71 and the second protrusion 72 may be metal. Also in this case, the first protrusion 71 and the second protrusion 72 can be prevented from becoming worn. The entire first protrusion 71 and entire second protrusion 72 may be formed of metal, or for example, only the surfaces of the first protrusion 71 and the second protrusion 72 may be formed of metal by plating. The first protrusion 71 and the second protrusion 72 may be formed of resin.

The first protrusion 71 is disposed on one side X1 in the first direction X with respect to the reflection surface 13 (see FIG. 5A) of the optical element 10. Accordingly, the first protrusion 71 can be disposed without blocking the light path.

The optical unit 1 includes a second preload unit 150 (see FIG. 5D) disposed on at least one of the movable body 2 and the support body 3. The second preload unit 150 applies the preload to at least the other of the movable body 2 and the support body 3 in the axial direction of the second swing axis A2. Accordingly, the movable body 2 can be prevented from displacing in the axial direction of the second swing axis A2 with respect to the support body 3. Even when a manufacturing error is generated in dimensions of each member, rattling or the like can be prevented from being generated in the axial direction of the second swing axis A2. In other words, the position of the movable body 2 can be prevented from displacing in the axial direction of the second swing axis A2.

The second preload unit 150 includes a magnet disposed on one of the movable body 2 and the support body 3 and a magnetic member disposed on the other of the movable body 2 and the support body 3. Accordingly, force attracting each other acts on the magnet and the magnetic member, so that the preload can be applied to at least the other of the movable body 2 and the support body 3 in the axial direction of the second swing axis A2 with a simple configuration. In the embodiment, the second preload unit 150 includes the second magnet 121 disposed on the movable body 2 and the magnetic member 73 disposed on the support body 3.

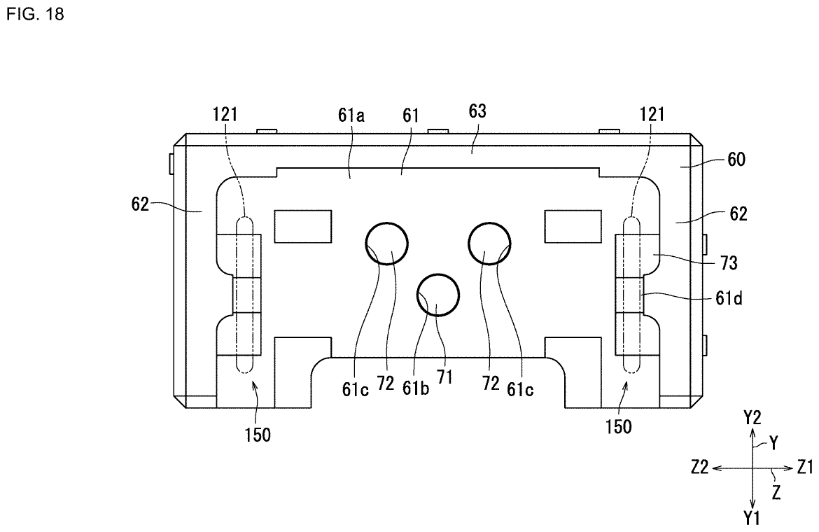

FIG. 18 is a view illustrating the second support 60, the first protrusion 71, the second protrusion 72, and the second magnet 121 of the optical unit 1 of the embodiment as viewed from the other side X2 in the first direction X. As illustrated in FIGS. 5D and 18, the third accommodation recess 61d is opposite to the second magnet 121 of the second swing mechanism 120 in the first direction X. The third accommodation recess 61d accommodates the magnetic member 73. The third accommodation recess 61d has a substantially rectangular shape. The magnetic member 73 has a rectangular shape.

The magnetic member 73 is a plate-like member made of a magnetic material. The magnetic member 73 is disposed on one side X1 in the first direction X with respect to the second magnet 121. The force attracting each other (hereinafter, also referred to as an attractive force) acts on the second magnet 121 and the magnetic member 73, so that the movable body 2 can be prevented from displacing in the first direction X with respect to the support body 3. The number of components can be prevented from increasing because the second magnet 121 of the second swing mechanism 120 is used. The optical unit 1 may include a magnet applying the attractive force with the magnetic member 73, separately from the second magnet 121 of the second swing mechanism 120.

In the embodiment, two magnetic members 73 are disposed in each third accommodation recesses 61d. In other words, the magnetic member 73 is disposed separately in a polarized direction of the second magnet 121 of the second swing mechanism 120. Accordingly, the area of the second magnet 121 becomes smaller than that in the case where the second magnet 121 is not separated. The second magnet 121 is polarized in the second direction Y as illustrated in FIG. 12. At this point, when the second swing mechanism 120 swings the movable body 2, the force is applied to the movable body 2 in the direction returning to a reference position due to the attractive force between the second magnet 121 and the magnetic member 73. As illustrated in FIG. 5B, the reference position is a position where the side surface unit 32 of the first support 30 and the side surface unit 62 of the second support 60 become parallel to each other.

As illustrated in FIGS. 16 and 18, the pair of side surface units 62 is disposed at both ends in the third direction Z of the support main body 61. The pair of side surface units 62 have shapes symmetrical to each other in the third direction Z. The side surface unit 62 includes an accommodation hole 62a in which a second coil 125 of the second swing mechanism 120 is disposed. The accommodation hole 62a penetrates the side surface unit 62 in the thickness direction. That is, the accommodation hole 62a penetrates the side surface unit 62 in the third direction Z.

The back surface unit 63 is disposed at the end on the other side Y2 in the second direction Y of the support main body 61. The back surface unit 63 includes an accommodation hole 63a in which a first coil 115 of the first swing mechanism 110 is disposed. The accommodation hole 63a penetrates the back surface unit 63 in the thickness direction. That is, the accommodation hole 63a penetrates the back surface unit 63 in the second direction Y.

A flexible printed circuit (FPC) 80 is disposed so as to cover the outside of the pair of side surface units 62 and the outside of the back surface unit 63. For example, the FPC 80 includes a semiconductor element, a connection terminal, and a wiring. The FPC 80 supplies the power to the first coil 115 of the first swing mechanism 110 and the second coil 125 of the second swing mechanism 120 at predetermined timing.

Specifically, as illustrated in FIG. 15, the FPC 80 includes a substrate 81, a connection terminal 82, a reinforcing plate 83, and a magnetic member 84. For example, the substrate 81 is made of a polyimide substrate. The substrate 81 has flexibility. The substrate 81 includes a plurality of pin insertion holes 81a. The pin insertion holes 81a are opposite to the first coil 115. A coil pin (not illustrated) of the first coil 115 is disposed in each pin insertion hole 81a.

The connection terminal 82 is disposed on the substrate 81. The connection terminal 82 is opposite to the first swing mechanism 110 and the second swing mechanism 120. The connection terminal 82 is electrically connected to a terminal of a Hall element (not illustrated). For example, four connection terminals 82 are disposed for one Hall element. Three reinforcing plates 83 are disposed on the substrate 81. The reinforcing plates 83 are opposite to the first swing mechanism 110 and the second swing mechanism 120. The reinforcing plate 83 prevents the substrate 81 from bending.

Three magnetic members 84 are disposed on the substrate 81. Two of the magnetic members 84 are opposite to the second magnet 121 of the second swing mechanism 120. The attractive force is generated between the second magnet 121 and the magnetic member 84 while the second coil 125 is not energized. Thus, the movable body 2 is disposed at the reference position in a rotation direction about the second swing axis A2. The remaining one of the magnetic members 84 is opposite to a first magnet 111 of the first swing mechanism 110. The attractive force is generated between the first magnet 111 and the magnetic member 84 while the first coil 115 is not energized. Thus, the movable body 2 is disposed at the reference position in a rotation direction about the first swing axis A1. The generation of the attractive force between the first magnet 111 and the magnetic member 84 can prevent the holder 20 from coming off to one side Y1 of the second direction Y.

As illustrated in FIGS. 5A and 5B, the optical unit 1 further includes the first swing mechanism 110. The first swing mechanism 110 swings the holder 20 with respect to the first support 30 about the first swing axis A1. Accordingly, the optical element 10 can be easily swung about each of the two swing axes (the first swing axis A1 and the second swing axis A2). The first swing mechanism 110 includes the first magnet 111 and the first coil 115. The first coil 115 is opposite to the first magnet 111 in the second direction Y.

The first magnet 111 is disposed in one of the holder 20 and the second support 60. On the other hand, the first coil 115 is disposed in the other of the holder 20 and the second support 60. Accordingly, the force acts on the first magnet 111 due to a magnetic field generated when the current flows through the first coil 115. The holder 20 swings with respect to the first support 30. Thus, the holder 20 can be swung with a simple configuration using the first magnet 111 and the first coil 115. In the embodiment, the first magnet 111 is disposed in the holder 20. The first coil 115 is disposed on the second support 60. Because the first coil 115 is disposed on the second support 60, the first coil 115 does not swing with respect to the second support 60. Accordingly, wiring can be easily performed on the first coil 115, for example, as compared with the case where the first coil 115 is disposed on the first support 30.

Specifically, the first magnet 111 is disposed in the back surface 21b of the holder 20. That is, the first magnet 111 is disposed at an end 20a on the other side Y2 in the second direction Y of the holder 20. The first magnet 111 includes an n-pole unit 111a including an n-pole and an s-pole unit 111b including an s-pole. The first magnet 111 is polarized in the first direction X.

The first coil 115 is disposed in the accommodation hole 63a of the back surface unit 63 of the second support 60. That is, the first coil 115 is disposed at an end 60a on the other side Y2 in the second direction Y of the second support 60. Accordingly, the first coil 115 and the first magnet 111 can be prevented from being disposed on the light path. Thus, the light path can be prevented from being blocked by the first coil 115 and the first magnet 111.

When the first coil 115 is energized, the magnetic field is generated around the first coil 115. Then, the force caused by the magnetic field acts on the first magnet 111. As a result, the holder 20 and the optical element 10 swing about the first swing axis A1 with respect to the first support 30 and the second support 60.

The second swing mechanism 120 swings the movable body 2 about the second swing axis A2. Specifically, the second swing mechanism 120 swings the first support 30 about the second swing axis A2 with respect to the second support 60. The second swing mechanism 120 includes the second magnet 121 and the second coil 125 opposite to the second magnet 121. The second magnet 121 is disposed on one of the first support 30 and the second support 60. On the other hand, the second coil 125 is disposed on the other of the first support 30 and the second support 60. Accordingly, the first support 30 swings with respect to the second support 60 by the magnetic field generated when the current flows through the second coil 125. Thus, the first support 30 can be swung with a simple configuration using the second magnet 121 and the second coil 125. In the embodiment, the second magnet 121 is disposed on the first support 30. The second coil 125 is disposed on the second support 60. When the second coil 125 is disposed on the second support 60, the second coil 125 does not swing with respect to the second support 60. Accordingly, the wiring can be easily performed on the second coil 125, for example, as compared with the case where the second coil 125 is disposed on the first support 30.

Specifically, the second magnet 121 is disposed in the accommodation recess 32f (see FIG. 12) of the side surface unit 32 of the first support 30. That is, the second magnet 121 is disposed at an end 30a in the direction intersecting the first direction X of the first support 30. In the embodiment, the second magnet 121 is disposed at the end 30a of the third direction Z. The second magnet 121 includes an n-pole unit 121a including the n-pole and an s-pole unit 121b including the s-pole. The second magnet 121 is polarized in the second direction Y intersecting the first direction X. Accordingly, the movable body 2 can be swung about the second swing axis A2 along the incident direction of light.

The second coil 125 is opposite to the second magnet 121 in the third direction Z. The second coil 125 is disposed in the accommodation hole 62a (see FIG. 16) of the side surface unit 62 of the second support 60. That is, the second coil 125 is disposed at an end 60b of the second support 60 in the third direction Z.

When the second coil 125 is energized, the magnetic field is generated around the second coil 125. Then, the force caused by the magnetic field acts on the second magnet 121. As a result, the first support 30, the holder 20, and the optical element 10 swing about the second swing axis A2 with respect to the second support 60.

When the optical unit 1 is used for the smartphone 200 as illustrated in FIG. 1, a Hall element (not illustrated) in the smartphone 200 detects the attitude of the smartphone 200. Then, the first swing mechanism 110 and the second swing mechanism 120 are controlled in response to the attitude of the smartphone 200. Preferably, the optical unit 1 can detect the attitude of the holder 20 with respect to the second support 60. In this case, the attitude of the holder 20 can be controlled with high accuracy with respect to the second support 60. For example, a gyro sensor may be used as a sensor that detects the attitude of the smartphone 200.

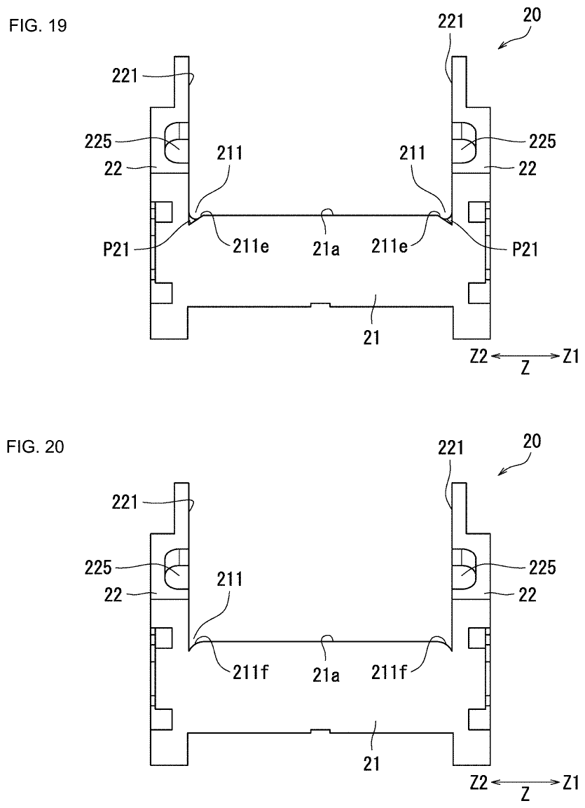

With reference to FIGS. 19 to 25, first to sixth modifications of the embodiment will be described below. Hereinafter, differences from the embodiment in FIGS. 1 to 18 will be mainly described.

The first modification of the embodiment of the present disclosure will be described with reference to FIG. 19. FIG. 19 is a view illustrating the structure of the holder 20 in the optical unit 1 of the first modification of the embodiment as viewed from the fourth direction α. In the first modification, unlike the embodiment in FIGS. 1 to 18, an example in which the depth of the groove 211 of the holder body 21 becomes deeper toward the inner side surface 221 will be described.

As illustrated in FIG. 19, the depth of the groove 211 becomes deeper toward the inner side surface 221. Accordingly, the position of the groove 211 corresponding to the portion of the metal mold that is most likely to be damaged by the erosion or the like can be made deeper than the other positions. Consequently, the unnecessary portion P21 can be effectively prevented from protruding toward the side of the optical element 10 from the support surface 21a.

In the first modification, the groove 211 is formed of a part of the inner side surface 221 and a flat inclination surface 211e extending in a direction inclined with respect to the first direction X from the end on one side X1 in the first direction X of the inner side surface 221. Accordingly, unlike the case where the groove 211 is formed of, for example, a part of the inner side surface 221 and the curved surface, the curved surface is not required to be formed in the metal mold, so that the time required for manufacturing the metal mold can be prevented.

Other structures and effects of the first modification are similar to those of the embodiment in FIGS. 1 to 18.

With reference to FIG. 20, the second modification of the embodiment of the present disclosure will be described. FIG. 20 is a view illustrating the structure of the holder 20 in the optical unit 1 of the second modification of the embodiment as viewed from the fourth direction X. As illustrated in FIG. 20, in the second modification, the groove 211 is formed of a part of the inner side surface 221 and a curved surface 211f extending from the end on one side X1 in the first direction X of the inner side surface 221 to the support surface 21a. The curved surface 211f is a curved surface having a protrusion shape toward the other side X2 in the first direction X.

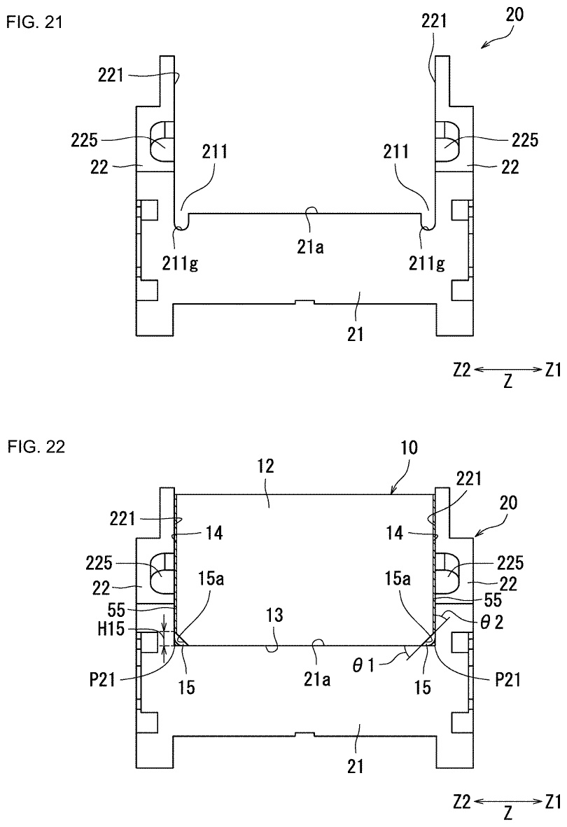

With reference to FIG. 21, the third modification of the embodiment of the present disclosure will be described. FIG. 21 is a view illustrating the structure of the holder 20 in the optical unit 1 of the third modification of the embodiment as viewed from the fourth direction X. As illustrated in FIG. 21, in the third modification, the groove 211 includes a bottom surface 211g formed of a curved surface. The bottom surface 211g is a curved surface having a protrusion shape toward one side X1 in the first direction X. Accordingly, the portion of the metal mold corresponding to the groove 211 can be formed by the curved surface, so that the erosion and the like of the metal mold can be prevented.

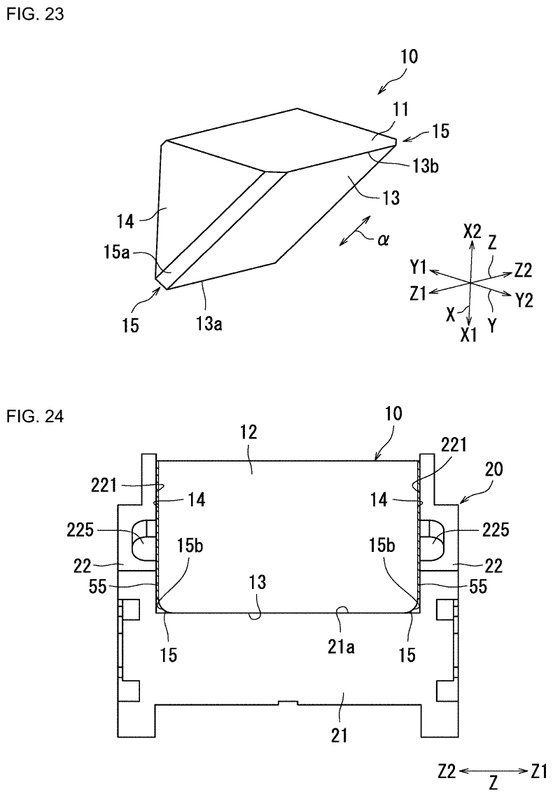

With reference to FIGS. 22 and 23, the fourth modification of the embodiment of the present disclosure will be described. FIG. 22 is a view illustrating the structures of the optical element 10 and the holder 20 in the optical unit 1 of the fourth modification of the embodiment as viewed from the fourth direction α. FIG. 23 is a perspective view illustrating the structure of the optical element 10 in the optical unit 1 of the fourth modification of the embodiment. In the fourth modification, unlike the embodiment in FIGS. 1 to 18 and the first to third modifications, an example in which the optical element 10 includes a chamfer 15 will be described.

As illustrated in FIGS. 22 and 23, the optical element 10 includes the reflection surface 13, the side surface 14, and the chamfer 15. The chamfer 15 is disposed at the connection unit between the reflection surface 13 and the side surface 14. Accordingly, even when the corner of the holder molding metal mold is damaged by the erosion or the like to form the unnecessary portion P21 at the connection unit between the support surface 21a of the holder 20 and the inner side surface 221, the unnecessary portion P21 can be prevented from coming into contact with the optical element 10. Consequently, the decrease in the attachment accuracy of the optical element 10 by the holder 20 can be prevented. In the fourth modification, the chamfers 15 are disposed at both ends of the optical element 10 in the third direction Z. The recess 21d of the holder body 21 is disposed between the chamfers 15 in the third direction Z.

In the fourth modification, a depth H15 of the chamfer 15 with respect to the reflection surface 13 is deepest at the position closest to the side surface 14. Accordingly, the position corresponding to the portion of the chamfer 15 where the erosion or the like is most likely to be generated in the metal mold can be deepest. Consequently, even when the corner of the metal mold is eroded, the unnecessary portion P21 can be prevented from contacting the optical element 10.

Further, the depth H15 of the chamfer 15 becomes deeper toward the side surface 14. Accordingly, the position of the chamfer 15 corresponding to the portion of the metal mold that is most likely to be damaged by the erosion or the like can be made deeper than other positions. Consequently, the unnecessary portion P21 can be effectively prevented from contacting the optical element 10.

In addition, the chamfer 15 is formed of the flat inclination surface 15a that is inclined with respect to the first direction X to connect the side surface 14 and the reflection surface 13. Therefore, unlike the case where the chamfer 15 is formed of, for example, the curved surface connecting the side surface 14 and the reflection surface 13, it is not necessary to form the curved surface in the metal mold, so that the time required for manufacturing the metal mold can be prevented.

An angle θ1 formed by the inclination surface 15a and the reflection surface 13 is greater than or equal to an angle θ2 formed by the inclination surface 15a and the side surface 14. Accordingly, the reflection surface 13 can be prevented from being narrowed by the chamfer 15. That is, the reflection surface 13 of the optical element 10 can be prevented from being narrowed. In the fourth modification, the angle θ1 formed by the inclination surface 15a and the reflection surface 13 is the same size (45 degrees) as the angle θ1 formed by the inclination surface 15a and the side surface 14.

The chamfer 15 extends from one end 13a to the other end 13b in the fourth direction α of the reflection surface 13. Accordingly, even when the unnecessary portion P21 is formed at any position in the fourth direction α in the connection unit between the support surface 21a of the holder 20 and the inner side surface 221, the unnecessary portion P21 can be prevented from contacting the optical element 10.

With reference to FIG. 24, the fifth modification of the embodiment of the present disclosure will be described. FIG. 24 is a view illustrating the structures of the optical element 10 and the holder 20 in the optical unit 1 of the fifth modification of the embodiment as viewed from the fourth direction α. As illustrated in FIG. 24, in the fifth modification, the chamfer 15 is formed of a curved surface 15b connecting the reflection surface 13 and the side surface 14.

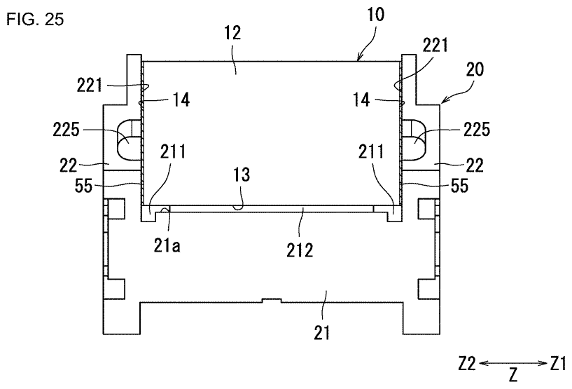

With reference to FIG. 25, the sixth modification of the embodiment of the present disclosure will be described. FIG. 25 is a view illustrating the structures of the optical element 10 and the holder 20 in the optical unit 1 of the sixth modification of the embodiment as viewed from the fourth direction α. In the sixth modification, unlike the embodiment in FIGS. 1 to 18 and the first to fifth modifications, an example in which the holder body 21 includes the spacer 212 will be described.

As illustrated in FIG. 25, the holder body 21 includes the spacer 212. The spacer 212 is disposed on the support surface 21a. The spacer 212 separates the optical element 10 from the support surface 21a. Accordingly, when the second adhesive member 55 is disposed between the side surface unit 22 of the holder 20 and the optical element 10, the second adhesive member 55 can be prevented from flowing onto the reflection surface 13 of the optical element 10 even when the second adhesive member 55 before curing flows onto the side of the support surface 21a (one side X1 in the first direction X).

The spacer 212 and the holder body 21 may be a single member or separate members. When the spacer 212 and holder body 21 are formed of the single member, the spacer 212 can be formed when the holder 20 is molded.

The embodiment (including modifications) of the present disclosure has been described above with reference to the drawings. However, the present disclosure is not limited to the above-described embodiment, and can be implemented in various modes without departing from a gist thereof. Various disclosures can be formed by appropriately combining the plurality of components disclosed in the above embodiment. For example, some components may be removed from all components illustrated in the embodiment. For example, constituent elements described in different embodiments may be appropriately combined. The components in the drawings are mainly and schematically illustrated for facilitating better understanding, and the thickness, length, number, interval, and the like of each illustrated component may be different from reality for the convenience of creating drawings. The material, shape, dimensions, and the like of each component described in the above embodiment are merely examples and are not particularly limited, and various modifications can be made without substantially departing from the effects of the present disclosure.

For example, in the above-described embodiment and modifications, the example in which the groove 211 or the chamfer 15 is disposed on both sides in the third direction Z has been described. However, the present disclosure is not limited thereto. The groove 211 or the chamfer 15 may be disposed in only one of the third directions Z. For example, when the holder 20 includes the holder body 21 and one side surface unit 22, the groove 211 may not be disposed on both sides in the third direction Z.

Furthermore, for example, in the fourth and fifth modifications, the example in which the chamfer 15 is formed of the inclination surface 15a or the curved surface 15b when the optical element 10 includes the chamfer 15 has been described. However, the present disclosure is not limited thereto. For example, the chamfer 15 may be formed in a stepped shape similarly to the groove 211 of the embodiment illustrated in FIGS. 1 to 18.

In the above-described embodiment, the example in which the optical unit 1 includes the first support 30, the second support 60, the first swing mechanism 110, the second swing mechanism 120, and the like is illustrated, but the present disclosure is not limited to this. The optical unit of the present disclosure needs not to include the first support, the second support, the first swing mechanism, and the second swing mechanism.

For example, the present disclosure can be applied to the optical unit.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An optical unit comprising:
an optical element that reflects light traveling on one side in a first direction to one side in a second direction intersecting the first direction; and
a holder that holds the optical element,
wherein the holder includes:
a holder body that extends in a third direction intersecting the first direction and the second direction; and
a side surface unit that extends from the holder body to an intersection direction intersecting the third direction,
the holder body includes amounting surface on which the optical element is mounted,
the side surface unit includes an inner side surface facing the optical element,
the inner side surface is connected to an end in the third direction of the mounting surface, and
the holder body includes a groove disposed at the end of the mounting surface,
or
the optical element includes:
a mounted surface mounted on the mounting surface;
a side surface facing the inner side surface; and
a chamfer disposed in a connection unit between the mounted surface and the side surface.

2. The optical unit according to claim 1, wherein the holder body includes the groove.

3. The optical unit according to claim 2, wherein a depth of the groove is deepest at a position closest to the inner side surface.

4. The optical unit according to claim 3, wherein the depth of the groove becomes deeper toward the inner side surface.

5. The optical unit according to claim 4, wherein the groove includes apart of the inner side surface and a flat inclination surface extending in a direction inclined with respect to the first direction from an end on one side in the first direction of the inner side surface.

6. The optical unit according to claim 2, wherein
the mounting surface is connected to the inner side surface along a fourth direction intersecting the third direction, and
the groove extends from one end to the other end in the fourth direction of the mounting surface.

7. The optical unit according to claim 2, wherein when viewed from the first direction, an end on one side in the second direction of the groove is located on the other side in the second direction as compared with an end on one side in the second direction of the mounting surface.

8. The optical unit according to claim 1, wherein
the optical element includes the mounted surface, the side surface, and the chamfer, and
a depth of the chamfer with respect to the mounted surface is deepest at a position closest to the side surface.

9. The optical unit according to claim 8, wherein a depth of the chamfer becomes deeper toward the side surface.

10. The optical unit according to claim 9, wherein the chamfer includes a flat inclination surface that is inclined with respect to the first direction to connect the side surface and the mounted surface.

11. The optical unit according to claim 10, wherein an angle formed by the inclination surface and the mounted surface is greater than or equal to an angle formed by the inclination surface and the side surface.

12. The optical unit according to claim 1, wherein
the groove is disposed at both ends in the third direction of the mounting surface,
or
the chamfer is disposed on both sides in the third direction of the optical element,
the holder body includes a recess disposed on the mounting surface, and
the recess is disposed between the grooves or between the chamfers in the third direction.

13. The optical unit according to claim 1, further comprising an adhesive member disposed between the side surface unit of the holder and the optical element,
wherein the adhesive member bonds the holder and the optical element.

14. The optical unit according to claim 13, wherein the holder body includes a spacer that is disposed on the mounting surface to separate the optical element from the mounting surface.
